(19) United States
(12) Patent Application Publication
(10) Pub. No.: US 2017/0248855 A1
(43) Pub. Date: Aug. 31, 2017

(54) ELECTROPHOTOGRAPHIC PHOTORECEPTOR, PROCESS CARTRIDGE, AND IMAGE FORMING APPARATUS

(71) Applicant: FUJI XEROX CO., LTD., Tokyo (JP)

(72) Inventor: Yoshiteru YAMADA, Kanagawa (JP)

(73) Assignee: FUJI XEROX CO., LTD., Tokyo (JP)

(21) Appl. No.: 15/205,044

(22) Filed: Jul. 8, 2016

(30) Foreign Application Priority Data
Feb. 28, 2016 (JP) 2016-037948

(51) Int. Cl. G03G 15/00

(52) U.S. Cl. CPC G03G 5/04; G03G 21/18

(57) ABSTRACT

An electrophotographic photoreceptor includes a conductive substrate and a single-layer photosensitive layer on the conductive substrate. The photosensitive layer includes a binder resin, at least one selected from a hydroxygallium phthalocyanine pigment and a chlorogallium phthalocyanine pigment, a hole transporting material, and an electron transporting material and has a Martens hardness Hm of 170 N/mm² or more and 200 N/mm² or less.

### CROSS-REFERENCE TO RELATED APPLICATIONS

This application is based on and claims priority under 35 USC 119 from Japanese Patent Application No. 2016-037948 filed Feb. 28, 2016.

### BACKGROUND

(i) Technical Field

The present invention relates to an electrophotographic photoreceptor, a process cartridge, and an image forming apparatus.

(ii) Related Art

In the electrophotographic image forming apparatuses of the related art, a toner image is formed on the surface of an electrophotographic photoreceptor and transferred to a recording medium through the process of charging, formation of an electrostatic latent image, development, and transferring.

### SUMMARY

According to an aspect of the invention, there is provided an electrophotographic photoreceptor including a conductive substrate, and a single-layer photosensitive layer on the conductive substrate. The photosensitive layer includes a binder resin, at least one charge generating material selected from a hydroxygallium phthalocyanine pigment and a chlorogallium phthalocyanine pigment, a hole transporting material, and an electron transporting material. The photosensitive layer has a Martens hardness Hm of 170 N/mm² or more and 200 N/mm² or less.

### BRIEF DESCRIPTION OF THE DRAWINGS

Exemplary embodiments of the present invention will be described in detail based on the following figures, wherein:

FIG. 1 is a schematic partial cross-sectional view of an electrophotographic photoreceptor according to an exemplary embodiment;

FIG. 2 is a schematic diagram illustrating an image forming apparatus according to an exemplary embodiment; and

FIG. 3 is a schematic diagram illustrating another image forming apparatus according to an exemplary embodiment.

### DETAILED DESCRIPTION

Exemplary embodiments of the invention are described below in detail.

### Electrophotographic Photoreceptor

An electrophotographic photoreceptor according to an exemplary embodiment (hereinafter, referred to simply as “photoreceptor”) includes a conductive substrate and a single-layer photosensitive layer disposed on the conductive substrate. The photosensitive layer includes a binder resin, at least one charge generating material selected from a hydroxygallium phthalocyanine pigment and a chlorogallium phthalocyanine pigment (hereinafter, referred to as “specific phthalocyanine pigment”), a hole transporting material, and an electron transporting material.

The photosensitive layer has a Martens hardness Hm of 170 N/mm² or more and 200 N/mm² or less. Martens hardness Hm is a measure of the degree of hardness, which is the quotient of the load required to form an indentation having a predetermined depth (in this exemplary embodiment, 0.5 μm) with a Vickers indenter divided by the surface area of the Vickers indenter.

Hereinafter, a photosensitive layer having a Martens hardness Hm of 170 N/mm² or more and 200 N/mm² or less is referred to as “low-hardness photosensitive layer”, and a photosensitive layer having a Martens hardness Hm of more than 200 N/mm² is referred to as “high-hardness photosensitive layer”.

It has been considered that photoreceptors including a single-layer photosensitive layer, that is, single-layer photoreceptors, are desirable as electrophotographic photoreceptors from the viewpoint of production cost and the like. In addition, with an increasing demand for the enhancement of image quality, a further reduction in the occurrence of image defects, which may be caused due to, for example, the defects of a photoreceptor, has been anticipated.

In an image forming apparatus including a photoreceptor, flaws may be formed in the surface of the photoreceptor (i.e., the photosensitive layer in this exemplary embodiment) by foreign matter (e.g., paper dust particles and abrasion powder particles) that is generated in or enters the apparatus. Specifically, the foreign matter is likely to become buried or lodged in the photosensitive layer, which results in formation of flaws in the surface of the photoreceptor. The foreign matter may reach the core of the photoreceptor, that is, a conductive support, without being removed.

When a photoreceptor has such flaws (i.e., foreign matter), the charge potential of the photoreceptor is likely to be reduced locally. Thus, the presence of the flaws adversely affects images during the formation of the images. For example, forming images by using such a photoreceptor increases the occurrence of image defects such as black spots and white spots.

It is considered that there is a correlation between ease of removal of the foreign matter from the surface of the photoreceptor and the hardness of the photosensitive layer. For example, when the hardness of a photosensitive layer is high, the surface of the photoreceptor is resistant to abrasion and the likelihood of the foreign matter, which is buried or lodged in the photosensitive layer, being removed may be reduced accordingly. The opposite is likely to occur when the hardness of the photosensitive layer is low.

Thus, the hardness of the photosensitive layer may be reduced in order to increase ease of removal of foreign matter present in the surface of the photoreceptor and to reduce the occurrence of image defects that may be caused by the foreign matter.

However, forming images by using a photoreceptor including a low-hardness photosensitive layer brings about a secondary problem; it becomes difficult to maintain high chargeability and a capability of forming images having a high density, which are the originally required functions of the photoreceptor.

Accordingly, the photoreceptor according to this exemplary embodiment includes a photosensitive layer that includes a binder resin, a hole transporting material, an electron transporting material, and a specific phthalocyanine pigment that serves as a charge generating material. Furthermore, the Martens hardness Hm of the photosensitive layer is controlled to fall within the above-described range.

Controlling the Martens hardness Hm of the photosensitive layer to fall within the above-described range means that, as described above, the hardness of the photosensitive layer is reduced. That is, in the photoreceptor according to this exemplary embodiment, the Martens hardness Hm of the photosensitive layer is reduced to 170 N/mm² such that the surface of the photoreceptor (i.e., photosensitive layer) can be abraded easily. This increases the likelihood of foreign matter buried or lodged in the surface of the photoreceptor being removed due to abrasion of the photosensitive layer.

However, reducing the Martens hardness Hm of the photosensitive layer to 170 N/mm² brings about a secondary problem during the formation of images; it becomes difficult to maintain high chargeability and a capability of forming images having a high density, which are the originally required functions of the photoreceptor. In order to address this, the photoreceptor according to this exemplary embodiment includes a photosensitive layer including a specific phthalocyanine pigment that serves as a charge generating material. This may enable the originally required functions of the photoreceptor to be maintained even when the hardness of the photosensitive layer is reduced to 170 N/mm².

The reasons for this are not clear. It is considered that, in the single-layer photosensitive layer, the specific phthalocyanine pigment not only exhibits an excellent charge generating ability but also contributes, in some way, to the limitation of the degradation of the originally required functions of the photoreceptor which may occur with a reduction in the hardness of the photosensitive layer.

An example of the photosensitive layer having a Martens hardness Hm that falls within the above-described range, which is included in the photoreceptor according to this exemplary embodiment, is a photosensitive layer having an adequately high residual solvent content. A specific example of such a photosensitive layer is a photosensitive layer in which the content of a residual solvent is 0.04% by weight or more and 1.6% by weight or less (preferably, 0.05% by weight or more and 1.6% by weight or less) of the total weight of the photosensitive layer.

The term “residual solvent content” used herein refers to, in the formation of a photosensitive layer by coating, the proportion of the weight of a solvent that remains in a dried coating film (i.e., photosensitive layer).

In the photoreceptor according to this exemplary embodiment, an adequate amount of solvent is made to remain in the photosensitive layer. This increases the likelihood of formation of a photosensitive layer having a Martens hardness Hm that falls within the above-described range.

It is considered that controlling the residual solvent content to fall within the above-described range reduces the degree at which resins included in the photosensitive layer adhere to one another to an adequate level and, consequently, the hardness of the photosensitive layer is reduced.

Thus, the likelihood of foreign matter buried or lodged in the surface of the photoreceptor being removed due to abrasion of the photosensitive layer is increased. High chargeability and a capability of forming images having a high density, which are the originally required functions of the photoreceptor, may be maintained for the same reasons as those described above.

A method for controlling the residual solvent content in the photosensitive layer to fall within the above range is described below.

The residual solvent content in the photosensitive layer can be measured with a thermal-extraction gas-chromatograph mass spectrometer in the following manner.

A sample having a weight of 2 mg or more and 3 mg or less is taken from a dried coating film (i.e., photosensitive layer). The sample is weighed, subsequently charged into a thermal extraction apparatus “PY2020D” produced by Frontier Laboratories Ltd., and heated to 400° C. The volatile matter of the sample is charged into a gas-chromatograph mass spectrometer “GCMS-QP2010” produced by Shimadzu Corporation through an interface having a temperature of 320° C., and the weight of the volatile matter is determined. Specifically, 1/51 (split ratio: 50:1) of the weight of matter that volatilized from the sample is charged into a column “Capillary Column UA-5” (inside diameter: 0.25 μm, length: 30 m) produced by Frontier Laboratories Ltd. with a helium gas that serves as a carrier gas at a linear velocity of 153.8 cm/sec (at a column temperature of 50° C., carrier gas flow rate: 1.50 ml/min, pressure: 50 kPa).

After the column is maintained at 50° C. for 3 minutes, it is heated to 400° C. at a rate of 8° C./min and maintained at 400° C. for 10 minutes in order to cause desorption of the volatile matter from the column. The volatile matter is subsequently charged into a mass spectrometer at an interface temperature of 320° C., and the peak area corresponding to the solvent is determined. For determining the weight of the solvent, a calibration curve that has been prepared using the same type of solvents having known weights is used. The residual solvent content is calculated by dividing the calculated weight of the solvent by the weight of the sample. Note that the above measurement method is merely an example and the measurement conditions may be changed appropriately depending on the temperature at which the resins included in the photosensitive layer decompose or change or the boiling point of the solvent used.

The electrophotographic photoreceptor according to this exemplary embodiment is described below in detail with reference to the attached drawings.

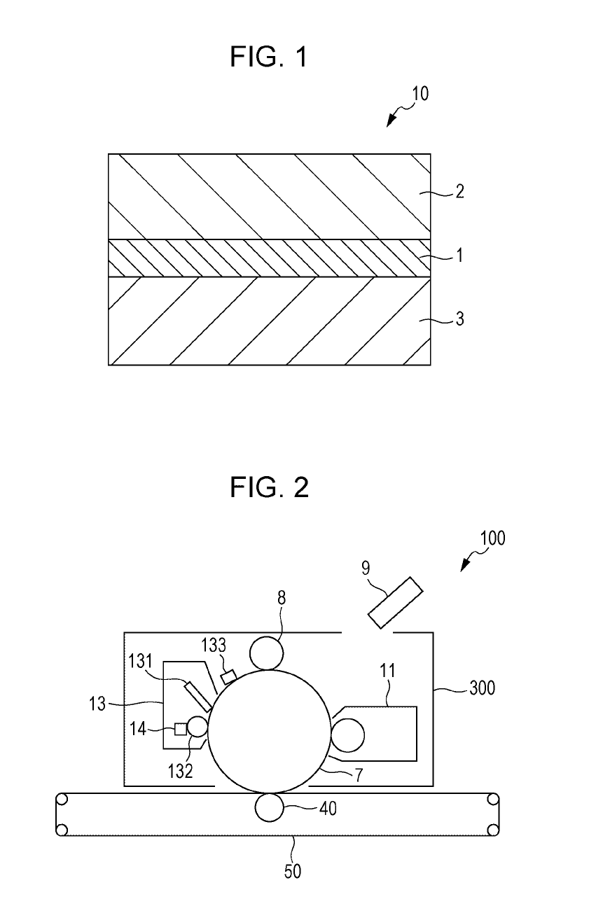

FIG. 1 is a schematic partial cross-sectional view of an electrophotographic photoreceptor 10 according to this exemplary embodiment.

The electrophotographic photoreceptor 10 illustrated in FIG. 1 includes, for example, a conductive substrate 3. An undercoat layer 1 and a single-layer photosensitive layer 2 are disposed on the conductive substrate 3 in this order.

The undercoat layer 1 is optional. In other words, the single-layer photosensitive layer 2 may be disposed on the conductive substrate 3 directly or above the conductive substrate 3 with the undercoat layer 1 interposed between the single-layer photosensitive layer 2 and the conductive substrate 3.

The layers constituting the electrophotographic photoreceptor according to this exemplary embodiment are each described below in detail. In the following description, reference numerals are omitted.

### Conductive Substrate

Examples of the conductive substrate include a metal sheet, a metal drum, and a metal belt that include a metal such as aluminium, copper, zinc, chromium, nickel, molybdenum, vanadium, indium, gold, or platinum or an alloy such as stainless steel. Other examples of the conductive substrate include a paper sheet, a resin film, and a belt on which a conductive compound such as a conductive polymer or indium oxide, a metal such as aluminium, palladium, or gold, or an alloy is deposited by coating, vapor deposition, or lamination. The term “conductive” used herein refers to having a volume resistivity of less than 10¹³ Ωcm.

In the case where the electrophotographic photoreceptor is used as a component of a laser printer, the surface of the conductive substrate may be roughened to a center-line-average roughness Ra of 0.04 μm or more and 0.5 μm or less in order to reduce the likelihood of interference fringes being formed when the photoreceptor is irradiated with a laser beam. Performing roughening for preventing the formation of interference fringes may be omitted in the case where a light source that emits incoherent light is used, but may increase the service life of the photoreceptor because it reduces the likelihood of defects being caused due to the irregularities in the surface of the conductive substrate.

For roughening the surface of the conductive substrate, for example, the following methods may be employed: wet honing in which a liquid prepared by suspending an abrasive in water is sprayed to the conductive substrate; centerless grinding in which the conductive substrate is continuously ground by being brought into pressure contact with a rotating grinding wheel; and anodic oxidation.

For performing roughening, instead of directly roughening the surface of the conductive substrate, alternatively, a layer composed of a resin containing conductive or semiconductive powder particles dispersed therein may be formed on the surface of the conductive substrate. In this method, the surface of the conductive substrate may become rough due to the presence of the particles dispersed in the layer.

For roughening the surface of the conductive substrate by anodic oxidation, anodic oxidation is performed in an electrolyte solution by using a conductive substrate made of a metal such as aluminium as an anode in order to form an oxide film on the surface of the conductive substrate. Examples of the electrolyte solution include a sulfuric acid solution and an oxalic acid solution. However, originally, the porous anodic oxide film formed by anodic oxidation is chemically active and susceptible to contamination. Furthermore, the resistivity of the porous anodic oxide film varies greatly depending on the environment. Therefore, a sealing treatment of the porous anodic oxide film, in which micropores formed in the oxide film are closed by cubical expansion caused due to hydration in pressurized steam or boiling water that may contain a salt of a metal such as nickel, may be performed in order to change the oxide film into a hydrous oxide film, which is more stable than an oxide film.

The thickness of the anodic oxide film may be, for example, 0.3 μm or more and 15 μm or less. When the thickness of the anodic oxide film falls within the above range, the injection barrier property of the oxide film may be enhanced. In addition, an increase in the residual potential due to the repeated use may be limited.

The conductive substrate may be treated with an acidic treatment liquid or subjected to a boehmite treatment.

The treatment of the conductive substrate with an acidic treatment liquid may be performed, for example, in the following manner. An acidic treatment liquid containing phosphoric acid, chromium acid, and hydrofluoric acid is prepared. The contents of the phosphoric acid, the chromium acid, and the hydrofluoric acid in the acidic treatment liquid are, for example, as follows: phosphoric acid: 10% by weight or more and 11% by weight or less; chromium acid: 3% by weight or more and 5% by weight or less; and hydrofluoric acid: 0.5% by weight or more and 2% by weight or less. The total concentration of these acids may be 13.5% by weight or more and 18% by weight or less. The treatment temperature may be, for example, 42° C. or more and 48° C. or less. The thickness of the coating film may be 0.3 μm or more and 15 μm or less.

In the boehmite treatment, for example, the conductive substrate is immersed in pure water having a temperature of 90° C. or more and 100° C. or less for 5 to 60 minutes or brought into contact with steam having a temperature of 90° C. or more and 120° C. or less for 5 to 60 minutes. The thickness of the coating film may be 0.1 μm or more and 5 μm or less. The resulting conductive substrate may optionally be subjected to anodic oxidation with an electrolyte solution having a low coating-film dissolubility, such as adipic acid, boric acid, a boric acid salt, a phosphoric acid salt, a phthalic acid salt, a maleic acid salt, a benzoic acid salt, a tartaric acid salt, or a citric acid salt.

### Undercoat Layer

The undercoat layer includes, for example, inorganic particles and a binder resin.

The inorganic particles may have, for example, a powder resistivity (i.e., volume resistivity) of 10² Ωcm or more and 10¹¹ Ωcm or less.

Among such inorganic particles having the above resistivity, for example, metal oxide particles such as tin oxide particles, titanium oxide particles, zinc oxide particles, and zirconium oxide particles are preferable and zinc oxide particles are particularly preferable.

The BET specific surface area of the inorganic particles may be, for example, 10 m²/g or more.

The volume-average diameter of the inorganic particles may be, for example, 50 nm or more and 2,000 nm or less and is preferably 60 nm or more and 1,000 nm or less.

The content of the inorganic particles is preferably, for example, 10% by weight or more and 80% by weight or less and is more preferably 40% by weight or more and 80% by weight or less of the amount of binder resin.

The inorganic particles may optionally be subjected to a surface treatment. It is possible to use two or more types of inorganic particles which have been subjected to different surface treatments or have different diameters in a mixture.

Examples of an agent used in the surface treatment include a silane coupling agent, a titanate coupling agent, an aluminate coupling agent, and a surfactant. In particular, a silane coupling agent is preferable and a silane coupling agent including an amino group is more preferable.

Examples of the silane coupling agent including an amino group include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more silane coupling agents may be used in a mixture. For example, a silane coupling agent including an amino group may be used in combination with another silane coupling agent. Examples of the other silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment of the inorganic particles with the surface-treating agent may be performed by any known method. Both dry process and wet process may be employed.

The amount of surface-treating agent used may be, for example, 0.5% by weight or more and 10% by weight or less of the amount of inorganic particles.

The undercoat layer may include an electron accepting compound (i.e., acceptor compound) in addition to the inorganic particles in order to enhance the long-term stability of electrical properties and carrier blocking property.

Examples of the electron accepting compound include the following electron transporting substances: quinones such as chloranil and bromanil; tetracyanoquinodimethanes; fluorenones such as 2,4,7-trinitrofluorenone and 2,4,5,7-tetranitro-9-fluorenone; oxadiazoles such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthones; thiophenes; and diphenoquinones such as 3,3′,5,5′-tetra-t-butyldiphenoquinone.

In particular, compounds including an anthraquinone structure may be used as an electron accepting compound. Examples of the compound including an anthraquinone structure include hydroxyanthraquinones, aminoanthraquinones, and aminohydroxyanthraquinones. Specific examples thereof include anthraquinone, alizarin, quinizarin, anthrarufin, and purpurin.

The electron accepting compound included in the undercoat layer may be dispersed in the undercoat layer together with the inorganic particles or deposited on the surfaces of the inorganic particles.

For depositing the electron accepting compound on the surfaces of the inorganic particles, for example, a dry process and a wet process may be employed.

In a dry process, for example, while the inorganic particles are stirred with a mixer or the like capable of producing a large shearing force, the electron accepting compound or a solution prepared by dissolving the electron accepting compound in an organic solvent is added dropwise or sprayed together with dry air or a nitrogen gas to the inorganic particles in order to deposit the electron accepting compound on the surfaces of the inorganic particles. The addition or spraying of the electron accepting compound may be done at a temperature equal to or lower than the boiling point of the solvent used.

Subsequent to the addition or spraying of the electron accepting compound, the resulting inorganic particles may optionally be baked at 100° C. or more. The temperature at which the inorganic particles are baked and the amount of time during which the inorganic particles are baked are not limited; the inorganic particles may be baked under appropriate conditions of temperature and time under which the intended electrophotographic properties are achieved.

In a wet process, for example, while the inorganic particles are dispersed in a solvent with a stirrer, an ultrasonic wave, a sand mill, an Attritor, a ball mill, or the like, the electron accepting compound is added to the resulting dispersion. After the dispersion has been stirred or dispersed, the solvent is removed such that the electron accepting compound is deposited on the surfaces of the inorganic particles. The removal of the solvent may be done by, for example, filtration or distillation. Subsequent to the removal of the solvent, the resulting inorganic particles may optionally be baked at 100° C. or more. The temperature at which the inorganic particles are baked and the amount of time during which the inorganic particles are baked are not limited; the inorganic particles may be baked under appropriate conditions of temperature and time under which the intended electrophotographic properties are achieved. In the wet process, moisture contained in the inorganic particles may be removed prior to the addition of the electron accepting compound. The removal of moisture contained in the inorganic particles may be done by, for example, heating the inorganic particles while being stirred in the solvent or by bringing the moisture to the boil together with the solvent.

The deposition of the electron accepting compound may be done prior or subsequent to the surface treatment of the inorganic particles with the surface-treating agent. Alternatively, the deposition of the electron accepting compound and the surface treatment using the surface-treating agent may be performed at the same time.

The content of the electron accepting compound may be, for example, 0.01% by weight or more and 20% by weight or less and is preferably 0.01% by weight or more and 10% by weight or less of the amount of inorganic particles.

Examples of the binder resin included in the undercoat layer include the following known materials: known high-molecular compounds such as acetal resins (e.g., polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenol resins, phenol-formaldehyde resins, melamine resins, urethane resins, alkyd resins, and epoxy resins; zirconium chelates; titanium chelates; aluminium chelates; titanium alkoxides; organic titanium compounds; and silane coupling agents.

Other examples of the binder resin included in the undercoat layer include charge transporting resins including a charge transporting group and conductive resins such as polyaniline.

Among the above binder resins, resins that are insoluble in a solvent included in a coating liquid used for forming a layer on the undercoat layer may be used as a binder resin included in the undercoat layer. In particular, resins produced by reacting at least one resin selected from the group consisting of thermosetting resins (e.g., a urea resin, a phenol resin, a phenol-formaldehyde resin, a melamine resin, a urethane resin, an unsaturated polyester resin, an alkyd resin, and an epoxy resin), polyamide resins, polyester resins, polyether resins, methacrylic resins, acrylic resins, polyvinyl alcohol resins, and polyvinyl acetal resins with a curing agent may be used.

In the case where two or more types of the above binder resins are used in combination, the mixing ratio between the binder resins may be set appropriately.

The undercoat layer may include various additives in order to enhance electrical properties, environmental stability, and image quality.

Examples of the additives include the following known materials: electron transporting pigments such as polycondensed pigments and azo pigments, zirconium chelates, titanium chelates, aluminium chelates, titanium alkoxides, organic titanium compounds, and silane coupling agents. The silane coupling agents, which may be used in the surface treatment of the inorganic particles as described above, may also be added to the undercoat layer as an additive.

Examples of silane coupling agents that may be used as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethylmethoxysilane, N,N-bis(2-hydroxyethyl)-3-aminopropyltriethoxysilane, and 3-chloropropyltrimethoxysilane.

Examples of the zirconium chelates include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelates include tetraisopropyl titanate, tetra-n-butyl titanate, butyl titanate dimer, tetra-(2-ethylhexyl) titanate, titanium acetylacetonate, polytitanium acetylacetonate, titanium octylene glycolate, titanium lactate ammonium salt, titanium lactate, titanium lactate ethyl ester, titanium triethanolamine, and polyhydroxy titanium stearate.

Examples of the aluminium chelates include aluminium isopropylate, monobutoxy aluminium diisopropylate, aluminium butyrate, diethyl acetoacetate aluminium diisopropylate, and aluminium tris(ethyl acetoacetate).

The above additives may be used alone. Alternatively, two or more types of the above compounds may be used in a mixture or in the form of a polycondensate.

The undercoat layer may have a Vickers hardness of 35 or more.

In order to reduce the formation of moiré fringes, the surface roughness (i.e., ten-point-average roughness) of the undercoat layer may be controlled to be 1/(4n) to ½ of the wavelength λ of the laser beam used as exposure light, where n is the refractive index of the layer that is to be formed on the undercoat layer.

Resin particles and the like may be added to the undercoat layer in order to adjust the surface roughness of the undercoat layer. Examples of the resin particles include silicone resin particles and crosslinked polymethyl methacrylate resin particles. The surface of the undercoat layer may be ground in order to adjust the surface roughness of the undercoat layer. For grinding the surface of the undercoat layer, buffing, sand blasting, wet honing, grinding, and the like may be performed.

The method for forming the undercoat layer is not limited, and known methods may be employed. For example, a coating film is formed using an undercoat-layer forming coating liquid prepared by mixing the above-described components with a solvent, and the coating film is dried and, as needed, heated.

Examples of the solvent used for preparing the undercoat-layer forming coating liquid include known organic solvents such as an alcohol solvent, an aromatic hydrocarbon solvent, a halogenated hydrocarbon solvent, a ketone solvent, a ketone alcohol solvent, an ether solvent, and an ester solvent.

Specific examples thereof include the following common organic solvents: methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

For dispersing the inorganic particles in the preparation of the undercoat-layer forming coating liquid, for example, known equipment such as a roll mill, a ball mill, a vibrating ball mill, an Attritor, a sand mill, a colloid mill, and a paint shaker may be used.

For coating the conductive substrate with the undercoat-layer forming coating liquid, for example, common methods such as blade coating, wire bar coating, spray coating, dip coating, bead coating, air knife coating, and curtain coating may be employed.

The thickness of the undercoat layer is preferably set to, for example, 15 μm or more and is more preferably set to 20 μm or more and 50 μm or less.

### Intermediate Layer

Although not illustrated in the drawings, an intermediate layer may optionally be interposed between the undercoat layer and the photosensitive layer.

The intermediate layer includes, for example, a resin. Examples of the resin included in the intermediate layer include the following high-molecular compounds: acetal resins (e.g., polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may include an organometallic compound. Examples of the organometallic compound that may be included in the intermediate layer include organometallic compounds containing a metal atom such as a zirconium atom, a titanium atom, an aluminium atom, a manganese atom, or a silicon atom.

The above compounds that may be included in the intermediate layer may be used alone. Alternatively, two or more types of the above compounds may be used in a mixture or in the form of a polycondensate.

In particular, the intermediate layer may include an organometallic compound containing a zirconium atom or a silicon atom.

The method for forming the intermediate layer is not limited, and known methods may be employed. For example, a coating film is formed using an intermediate-layer forming coating liquid prepared by mixing the above-described components with a solvent, and the coating film is dried and, as needed, heated.

For forming the intermediate layer, common coating methods such as dip coating, push coating, wire bar coating, spray coating, blade coating, knife coating, and curtain coating may be employed.

The thickness of the intermediate layer may be set to, for example, 0.1 μm or more and 3 μm or less. It is possible to use the intermediate layer as an undercoat layer.

### Single-Layer Photosensitive Layer

The Martens hardness Hm of the single-layer photosensitive layer according to this exemplary embodiment is set to 170 N/mm² or more and 200 N/mm² or less, is preferably set to 175 N/mm² or more and 195 N/mm² or less, and is more preferably set to 180 N/mm² or more and 190 N/mm² or less in order to increase ease of removal of foreign matter present in the surface of the photoreceptor and to maintain high chargeability and a capability of forming images having a high density.

The Martens hardness Hm of the photosensitive layer can be measured by the following method.

A photoreceptor including the photosensitive layer that is to be measured is placed on a measuring equipment “PICODENTOR HM500” produced by Fischer Instruments in an environment of 23° C. and 30% RH. A Vickers indenter is pressed against the surface of the photoreceptor (i.e., photosensitive layer), and the amount of load at which the surface of the photoreceptor is pressed with the indenter is increased continuously. The amount of test load at which the indenter is pressed 0.5 μm is divided by the surface area of the indenter, and the quotient is considered to be the Martens hardness Hm of the photosensitive layer.

The measurement of Martens hardness Hm is done at the following five positions: positions 40 mm and 80 mm from the respective ends of the photoreceptor in the axis direction and at the center of the photoreceptor in the axis direction. The average of the Martens hardness Hm measured at the five positions is considered to be the “Martens hardness Hm” of the photosensitive layer.

The photosensitive layer to be measured may be a photosensitive layer prepared by cutting the photoreceptor.

The method for controlling the Martens hardness Hm of the photosensitive layer to fall within the above-described range is described below.

The thickness of the single-layer photosensitive layer is preferably set to 15 μm or more and 40 μm or less, is more preferably set to 18 μm or more and 30 μm or less, and is further preferably set to 20 μm or more and 25 μm or less.

The single-layer photosensitive layer according to this exemplary embodiment includes a binder resin, a specific phthalocyanine pigment that serves as a charge generating material, a hole transporting material, an electron transporting material, and, as needed, other additives. The components of the single-layer photosensitive layer are described below in detail.

### Binder Resin

Examples of the binder resin include, but are not limited to, polycarbonate resins, polyester resins, polyarylate resins, methacrylic resins, acrylic resins, polyvinyl chloride resins, polyvinylidene chloride resins, polystyrene resins, polyvinyl acetate resins, a styrene-butadiene copolymer, a vinylidene chloride-acrylonitrile copolymer, a vinyl chloride-vinyl acetate copolymer, a vinyl chloride-vinyl acetate-maleic anhydride copolymer, silicone resins, a silicone-alkyd resin, a phenol-formaldehyde resin, a styrene-alkyd resin, poly-N-vinylcarbazole, and polysilane. The above binder resins may be used alone or in a mixture of two or more.

Among the above binder resins, in order to readily control the Martens hardness Hm of the photosensitive layer to fall within the above-described range, polycarbonate resins, polystyrene resins, and polyethylene terephthalate resins may be used. In particular, a polycarbonate resin having a viscosity-average molecular weight of 30,000 or more and 80,000 or less, a polystyrene resin having a viscosity-average molecular weight of 30,000 or more and 60,000 or less, and a polyethylene terephthalate resin having a viscosity-average molecular weight of 30,000 or more and 60,000 or less may be used.

The content of the binder resin may be 35% by weight or more and 60% by weight or less and is desirably 20% by weight or more and 35% by weight or less of the total solid content of the photosensitive layer.

The viscosity-average molecular weight of the binder resin can be measured by the one-point measurement method described below.

The photosensitive layer that is to be measured is made to be exposed at the surface of the photoreceptor. A piece of the photosensitive layer is taken as a measurement sample.

Subsequently, a binder resin contained in the measurement sample is extracted. A portion (1 g) of the extracted binder resin is dissolved in 100 cm³ of methylene chloride, and the specific viscosity ηsp of the resulting solution is measured with an Ubbelohde viscometer at 25° C. Limiting viscosity [η] (cm³/g) is calculated on the basis of the following relational expression:

ηsp/c=[η]+0.45[η]²c, where c represents a concentration(g/cm³).

Viscosity-average molecular weight My is calculated using the following relational expression given by H. Schnell.

[η]=1.23×10⁻⁴Mv^{0.83}

Charge Generating Material

At least one pigment selected from a hydroxygallium phthalocyanine pigment and a chlorogallium phthalocyanine pigment is used as a charge generating material in order to limit the degradation of the originally required functions of the photoreceptor which may occur with a reduction in the hardness of the photosensitive layer.

The above pigments may be used alone as a charge generating material. Alternatively, two or more types of the above pigments may be used in combination as needed.

In particular, the hydroxygallium phthalocyanine pigment may be, for example, a hydroxygallium phthalocyanine pigment having a maximum peak wavelength at 810 nm or more and 839 nm or less in a spectral absorption spectrum that covers the range of 600 nm or more and 900 nm or less, because such hydroxygallium phthalocyanine pigment is capable of being dispersed at a higher degree. That is, when such hydroxygallium phthalocyanine pigment is used as a material of the electrophotographic photoreceptor, excellent dispersibility, sufficiently high sensitivity, sufficiently high chargeability, and a sufficiently high dark decay characteristic are likely to be achieved.

The hydroxygallium phthalocyanine pigment having a maximum peak wavelength at 810 nm or more and 839 nm or less may have an average particle diameter that falls within a specific range and a BET specific surface area that falls within a specific range. Specifically, the average particle diameter of such a hydroxygallium phthalocyanine pigment is preferably 0.20 μm or less and is more preferably 0.01 μm or more and 0.15 μm or less, and the BET specific surface area of such a hydroxygallium phthalocyanine pigment is preferably 45 m²/g or more, is more preferably 50 m²/g or more, and is particularly preferably 55 m²/g or more and 120 m²/g or less. The average particle diameter of the hydroxygallium phthalocyanine pigment is the volume-average particle diameter (i.e., d50 average particle diameter) of the hydroxygallium phthalocyanine pigment which is measured with a laser diffraction/scattering particle size distribution analyzer “LA-700” produced by HORIBA, Ltd. The BET specific surface area of the hydroxygallium phthalocyanine pigment is measured by a nitrogen purge method with a BET specific surface area analyzer “Flowsorb II2300” produced by Shimadzu Corporation.

If the average particle diameter of the hydroxygallium phthalocyanine pigment is larger than 0.20 μm or the specific surface area of the hydroxygallium phthalocyanine pigment is less than 45 m²/g, the size of the pigment particles may be excessively large or the pigment particles may form aggregates. This increases the occurrence of degradation of the properties such as dispersibility, sensitivity, chargeability, and a dark decay characteristic and, as a result, the defects of image quality may be increased.

The maximum particle diameter (i.e., maximum primary-particle diameter) of the hydroxygallium phthalocyanine pigment is preferably 1.2 μm or less, is more preferably 1.0 μm or less, and is further preferably 0.3 μm or less. If the maximum particle diameter of the hydroxygallium phthalocyanine pigment exceeds the above range, the occurrence of black spots may be increased.

The hydroxygallium phthalocyanine pigment may have an average particle diameter of 0.2 μm or less, a maximum particle diameter of 1.2 μm or less, and a specific surface area of 45 m²/g or more in order to reduce the inconsistencies in density which may occur due to exposure of the photoreceptor to a fluorescent lamp or the like.

The hydroxygallium phthalocyanine pigment may be a V-Type hydroxygallium phthalocyanine pigment having a diffraction peak at, at least, Bragg angles (2θ±0.2°) of 7.3°, 16.0°, 24.9°, and 28.0° in an X-ray diffraction spectrum measured with the CuKα radiation.

Although the type of the chlorogallium phthalocyanine pigment is not limited, the chlorogallium phthalocyanine pigment may have a diffraction peak at Bragg angles (2θ±0.2°) of 7.4°, 16.6°, 25.5°, and 28.3°. Such a chlorogallium phthalocyanine pigment serves as a material of the electrophotographic photoreceptor material which has excellent sensitivity.

The suitable maximum peak wavelength in a spectral absorption spectrum, average particle diameter, maximum particle diameter, and specific surface area of the chlorogallium phthalocyanine pigment are the same as those of the hydroxygallium phthalocyanine pigment.

The content of the charge generating material is not limited but is preferably 1.4% by weight or more and 2.6% by weight or less and is more preferably 1.5% by weight or more and 2.3% by weight or less of the total solid content of the photosensitive layer in order to maintain high chargeability and a capability of forming images having a high density, which are the originally required functions of the photoreceptor.

Hole Transporting Material

Examples of the hole transporting material include, but are not limited to, oxadiazole derivatives such as 2,5-bis(p-diethylaminophenyl)-1,3,4-oxadiazole; pyrazoline derivatives such as 1,3,5-triphenyl-pyrazoline and 1-[pyridyl-(2)]-3-(p-diethylaminostyryl)-5-(p-diethylaminostyryl)pyrazoline; aromatic tertiary amines such as triphenylamine, N,N′-bis(3,4-dimethylphenyl)biphenyl-4-amine, tri(p-methylphenyl)aminyl-4-amine, and dibenzylaniline; aromatic tertiary diamines such as N,N′-bis(3-methylphenyl)-N,N′-diphenylbenzidine; 1,2,4-triazine derivative such as 3-(4′-dimethylaminophenyl)-5,6-di-(4′-methoxyphenyl)-1,2,4-triazine; hydrazone derivatives such as 4-diethylaminobenzaldehyde-1,1-diphenylhydrazone; quinazoline derivatives such as 2-phenyl-4-styryl-quinazoline; benzofuran derivatives such as 6-hydroxy-2,3-di(p-methoxyphenyl)benzofuran; α-stilbene derivatives such as p-(2,2-diphenylvinyl)-N,N-diphenylaniline; enamine derivatives; carbazole derivatives such as N-ethylcarbazole; poly-N-vinylcarbazole and the derivatives thereof; and polymers including a backbone or a side chain that is a group constituted by the above compounds. The above hole transporting materials may be used alone or in combination of two or more.

Among the above hole transporting materials, aromatic tertiary amines may be used from the viewpoint of the mobility of charge. In particular, the triarylamine-based hole transporting material represented by General Formula (HT1) below and the butadiene-based hole transporting material represented by General Formula (HT2) below may be used. The triarylamine-based hole transporting material may be the benzidine-based hole transporting material represented by General Formula (HT1a) below.

The triarylamine-based hole transporting material (HT1) is described below.

The triarylamine-based hole transporting material (HT1) is a hole transporting material represented by General Formula (HT1) below.

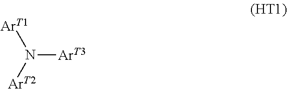

In General Formula (HT1), Ar^{T1}, Ar^{T2}, and Ar^{T3} each independently represent an aryl group or a —C₆H₄—C(R^{T4})═C(R^{T5})(R^{T6}) group, where R^{T4}, R^{T5}, and R^{T6} each independently represent a hydrogen atom, an alkyl group, or an aryl group; and R^{T5} and R^{T6} may be bonded to each other to form a hydrocarbon ring structure.

An example of the aryl group represented by Ar^{T1}, Ar^{T2}, and Ar^{T3} in General Formula (HT1) above is an aryl group having 6 to 15 carbon atoms, preferably 6 to 9 carbon atoms, and more preferably 6 to 8 carbon atoms.

Specific examples of such an aryl group include a phenyl group, a naphthyl group, and a fluorene group.

Among the above aryl groups, in particular, a phenyl group may be used.

Examples of the alkyl group represented by R^{T4}, R^{T5}, and R^{T6} in General Formula (HT1) above are the same as the examples of the alkyl group represented by R^{C21}, R^{C22}, and R^{C23} in General Formula (HT1a), which are described below. The preferable range of the alkyl group represented by R^{T4}, R^{T5}, and R^{T6} in General Formula (HT1) above are also the same as those of the alkyl group represented by R^{C21}, R^{C22}, and R^{C23} in General Formula (HT1a).

Examples of the aryl group represented by R^{T4}, R^{T5}, and R^{T6} in the General Formula (HT1) are the same as the above examples of aryl group represented by Ar^{T1}, Ar^{T2}, and Ar^{T3}. The preferable range of the aryl group represented by R^{T4}, R^{T5}, and R^{T6} in the General Formula (HT1) are also the same as those of aryl group represented by Ar^{T1}, Ar^{T2}, and Ar^{T3}.

The substituent groups represented by Ar^{T1}, Ar^{T2}, Ar^{T3}, R^{T4}, R^{T5}, and R^{T6} in General Formula (HT1) may further have a substituent subgroup. Examples of the substituent subgroup include a halogen atom, an alkyl group having 1 to 5 carbon atoms, an alkoxy group having 1 to 5 carbon atoms, and an aryl group having 6 to 10 carbon atoms. Another example of the substituent subgroup of the substituent groups is an amino group substituted with an alkyl group having 1 to 3 carbon atoms.

Only one type of the triarylamine-based hole transporting material (HT1) may be used alone. Alternatively, two or more types of the triarylamine-based hole transporting materials (HT1) may be used in combination.

Among the triarylamine-based hole transporting materials represented by General Formula (HT1), a triarylamine-based hole transporting material including the —C₆H₄—C(R^{T4})═C(R^{T5})(R^{T6}) group may be used from the viewpoint of the mobility of charge. In particular, the triarylamine-based hole transporting material represented by Formula (HT1-4) below, which is one of the specific examples of the triarylamine-based hole transporting material (HT1), may be used.

The benzidine-based hole transporting material (HT1a) is described below.

The benzidine-based hole transporting material (HT1a) is a hole transporting material represented by General Formula (HT1a) below.

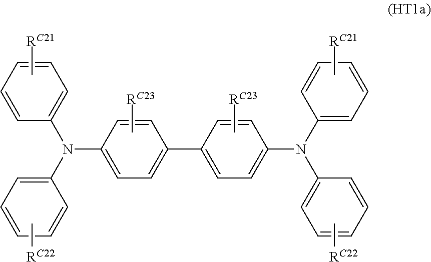

In General Formula (HT1a), R^{C21}, R^{C22}, and R^{C23} each independently represent a hydrogen atom, a halogen atom, an alkyl group having 1 to 10 carbon atoms, an alkoxy group having 1 to 10 carbon atoms, or an aryl group having 6 to 10 carbon atoms.

Examples of the halogen atom represented by R^{C21}, R^{C22} and R^{C23} in General Formula (HT1a) include a fluorine atom, a chlorine atom, a bromine atom, and an iodine atom. Among the above halogen atoms, a fluorine atom and a chlorine atom are preferable, and a chlorine atom is more preferable.

Examples of the alkyl group represented by R^{C21}, R^{C22} and R^{C23} in General Formula (HT1a) include linear and branched alkyl groups having 1 to 10 carbon atoms, preferably 1 to 6 carbon atoms, and more preferably 1 to 4 carbon atoms.

Specific examples of the linear alkyl group include a methyl group, an ethyl group, an n-propyl group, an n-butyl group, an n-pentyl group, an n-hexyl group, an n-heptyl group, an n-octyl group, an n-nonyl group, and an n-decyl group.

Specific examples of the branched alkyl group include an isopropyl group, an isobutyl group, a sec-butyl group, a tert-butyl group, an isopentyl group, an neopentyl group, a tert-pentyl group, an isohexyl group, a sec-hexyl group, a tert-hexyl group, an isoheptyl group, an sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Among the above alkyl groups, in particular, lower alkyl groups such as a methyl group, an ethyl group, and an isopropyl group may be used.

Examples of the alkoxy group represented by R^{C21}, R^{C22} and R^{C23} in General Formula (HT1a) include linear and branched alkoxy groups having 1 to 10 carbon atoms, preferably 1 to 6 carbon atoms, and more preferably 1 to 4 carbon atoms.

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Among the above alkoxy groups, in particular, a methoxy group may be used.

Examples of the aryl group represented by R^{C21}, R^{C22}, and R^{C23} in General Formula (HT1a) include aryl groups having 6 to 10 carbon atoms, preferably 6 to 9 carbon atoms, and more preferably 6 to 8 carbon atoms.

Specific examples of the aryl groups include a phenyl group and a naphthyl group.

Among the above aryl groups, in particular, a phenyl group may be used.

The substituent groups represented by R^{C21}, R^{C22} and R^{C23} in General Formula (HT1a) may further include a substituent subgroup. Examples of the substituent subgroup include the atoms and groups described above as examples, such as a halogen atom, an alkyl group, an alkoxy group, and an aryl group.

Only one type of the benzidine-based hole transporting material (HT1a) may be used alone. Alternatively, two or more types of the benzidine-based hole transporting material (HT1a) may also be used in combination.

Specific examples of the triarylamine-based hole transporting material (HT1) and the benzidine-based hole transporting material (HT1a) include, but are not limited to, the following compounds represented by Formulae (HT1-1) to (HT1-7).

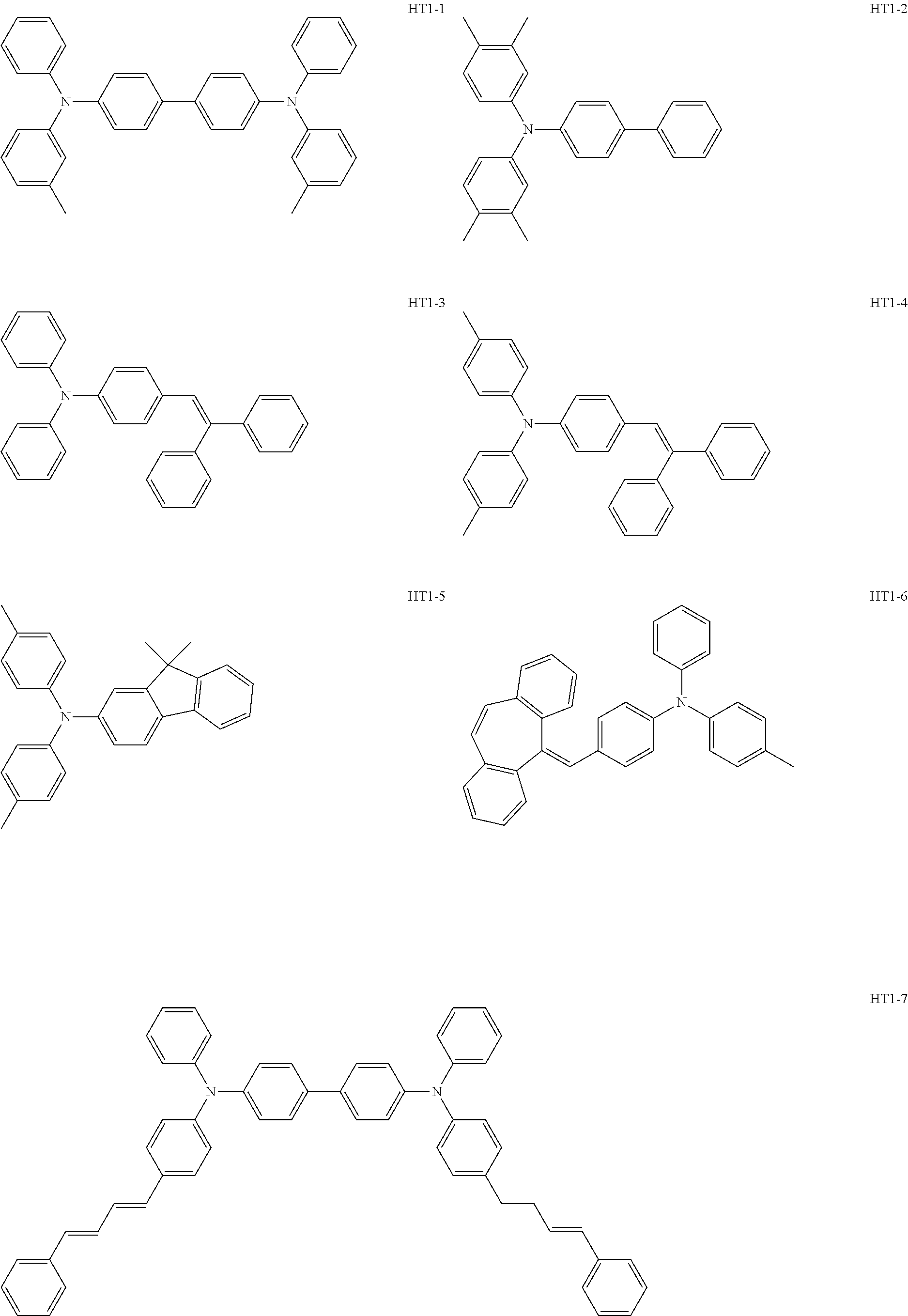

The butadiene-based hole transporting material (HT2) is described below.

The butadiene-based hole transporting material (HT2) is the hole transporting material represented by General Formula (HT2) below.

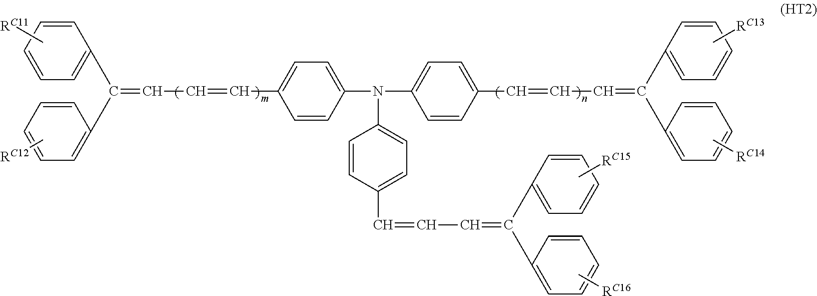

In General Formula (HT2), R^{C11}, R^{C12}, R^{C13}, R^{C14}, R^{C15}, and R^{C16} each independently represent a hydrogen atom, a halogen atom, an alkyl group having 1 to 20 carbon atoms, an alkoxy group having 1 to 20 carbon atoms, or an aryl group having 6 to 30 carbon atoms; a pair of adjacent substituent groups may be bonded to each other to form a hydrocarbon ring structure; and n and m each independently represent 0, 1, or 2.

Examples of the halogen atom represented by R^{C11}, R^{C12}, R^{C13}, R^{C14}, R^{C15}, and R^{C16} in General Formula (HT2) include a fluorine atom, a chlorine atom, a bromine atom, and an iodine atom. Among the above halogen atoms, a fluorine atom and a chlorine atom are preferable, and a chlorine atom is more preferable.

Examples of the alkyl group represented by R^{C11}, R^{C12}, R^{C13}, R^{C14}, R^{C15}, and R^{C16} in General Formula (HT2) include linear and branched alkyl groups having 1 to 20 carbon atoms, preferably 1 to 6 carbon atoms, and more preferably 1 to 4 carbon atoms.

Specific examples of the linear alkyl group include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, and an n-icosyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isoundecyl group, a sec-undecyl group, a tert-undecyl group, a neoundecyl group, an isododecyl group, a sec-dodecyl group, a tert-dodecyl group, a neododecyl group, an isotridecyl group, a sec-tridecyl group, a tert-tridecyl group, a neotridecyl group, an isotetradecyl group, a sec-tetradecyl group, a tert-tetradecyl group, a neotetradecyl group, a 1-isobutyl-4-ethyloctyl group, an isopentadecyl group, a sec-pentadecyl group, a tert-pentadecyl group, a neopentadecyl group, an isohexadecyl group, a sec-hexadecyl group, a tert-hexadecyl group, a neohexadecyl group, a 1-methylpentadecyl group, an isoheptadecyl group, a sec-heptadecyl group, a tert-heptadecyl group, a neoheptadecyl group, an isooctadecyl group, a sec-octadecyl group, a tert-octadecyl group, a neooctadecyl group, an isononadecyl group, a sec-nonadecyl group, a tert-nonadecyl group, a neononadecyl group, a 1-methyloctyl group, an isoicosyl group, a sec-icosyl group, a tert-icosyl group, and a neoicosyl group.

Among the above alkyl groups, in particular, lower alkyl groups such as a methyl group, an ethyl group, and an isopropyl group may be used.

Examples of the alkoxy group represented by R^{C11}, R^{C12}, R^{C13}, R^{C14}, R^{C15}, and R^{C16} in General Formula (HT2) include linear and branched alkoxy groups having 1 to 20 carbon atoms, preferably 1 to 6 carbon atoms, and more preferably 1 to 4 carbon atoms.

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, an n-undecyloxy group, an n-dodecyloxy group, an n-tridecyloxy group, an n-tetradecyloxy group, an n-pentadecyloxy group, an n-hexadecyloxy group, an n-heptadecyloxy group, an n-octadecyloxy group, an n-nonadecyloxy group, and an n-icosyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, a tert-decyloxy group, an isoundecyloxy group, a sec-undecyloxy group, a tert-undecyloxy group, a neoundecyloxy group, an isododecyloxy group, a sec-dodecyloxy group, a tert-dodecyloxy group, a neododecyloxy group, an isotridecyloxy group, a sec-tridecyloxy group, a tert-tridecyloxy group, a neotridecyloxy group, an isotetradecyloxy group, a sec-tetradecyloxy group, a tert-tetradecyloxy group, a neotetradecyloxy group, a 1-isobutyl-4-ethyloctyloxy group, an isopentadecyloxy group, a sec-pentadecyloxy group, a tert-pentadecyloxy group, a neopentadecyloxy group, an isohexadecyloxy group, a sec-hexadecyloxy group, a tert-hexadecyloxy group, a neohexadecyloxy group, a 1-methylpentadecyloxy group, an isoheptadecyloxy group, a sec-heptadecyloxy group, a tert-heptadecyloxy group, a neoheptadecyloxy group, an isooctadecyloxy group, a sec-octadecyloxy group, a tert-octadecyloxy group, a neooctadecyloxy group, an isononadecyloxy group, a sec-nonadecyloxy group, a tert-nonadecyloxy group, a neononadecyloxy group, a 1-methyloctyloxy group, an isoicosyloxy group, a sec-icosyloxy group, a tert-icosyloxy group, and a neoicosyloxy group.

Among the above alkoxy groups, in particular, a methoxy group may be used.

Examples of the aryl group represented by R^{C11}, R^{C12}, R^{C13}, R^{C14}, R^{C15}, and R^{C16} in General Formula (HT2) include aryl groups having 6 to 30 carbon atoms, preferably 6 to 20 carbon atoms, and more preferably 6 to 16 carbon atoms.

Specific examples of such aryl groups include a phenyl group, a naphthyl group, a phenanthryl group, and a biphenylyl group.

Among the above aryl groups, in particular, a phenyl group and a naphthyl group may be used.

The substituent groups represented by R^{C11}, R^{C12}, R^{C13}, R^{C14}, R^{C15}, and R^{C16} in General Formula (HT2) may further include a substituent subgroup. Examples of the substituent subgroup include the atoms and groups described above as examples, such as a halogen atom, an alkyl group, an alkoxy group, and an aryl group.

Examples of a group with which a pair of adjacent substituent groups selected from R^{C11}, R^{C12}, R^{C13}, R^{C14}, R^{C15}, and R^{C16} in General Formula (HT2), that is, for example, the pair of R^{C11} and R^{C12}, the pair of R^{C13} and R^{C14}, or the pair of R^{C15} and R^{C16}, may be bonded to each other to form a hydrocarbon ring structure include a single bond, a 2,2′-methylene group, a 2,2′-ethylene group, and a 2,2′-vinylene group. In particular, a single bond and a 2,2′-methylene group may be used.

Specific examples of the hydrocarbon ring structure include a cycloalkane structure, a cycloalkene structure, and a cycloalkane polyene structure.

In General Formula (HT2), in particular, n and m may be 1.

It is preferable that, in General Formula (HT2), R^{C11}, R^{C12}, R^{C13}, R^{C14}, R^{C15}, and R^{C16} represent a hydrogen atom, an alkyl group having 1 to 20 carbon atoms, or an alkoxy group having 1 to 20 carbon atoms and that m and n represent 1 or 2 in order to form a photosensitive layer having high hole transportability, that is, a hole transporting layer. It is more preferable that R^{C11}, R^{C12}, R^{C13}, R^{C14}, R^{C15}, and R^{C16} represent a hydrogen atom and that m and n represent 1.

In other words, it is more preferable that the butadiene-based hole transporting material (HT2) is the hole transporting material represented by structural formula (HT2a) below, which is the exemplified compound (HT2-3).

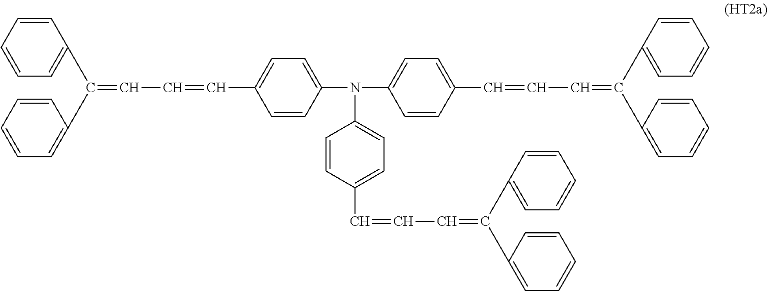 [SMILES: C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1]

Specific examples of the butadiene-based hole transporting material (HT2) include, but are not limited to, the following compounds represented by Formulae (HT2-1) to (HT2-24).

| Exemplified | | | | | | | | |
|---|---|---|---|---|---|---|---|---|
| compound No. | m | n | R^{C11} | R^{C12} | R^{C13} | R^{C14} | R^{C15} | R^{C16} |
| HT2-1 | 1 | 1 | 4-CH₃ | 4-CH₃ | 4-CH₃ | 4-CH₃ | H | H |
| HT2-2 | 2 | 2 | H | H | H | H | 4-CH₃ | 4-CH₃ |
| HT2-3 | 1 | 1 | H | H | H | H | H | H |
| HT2-4 | 2 | 2 | H | H | H | H | H | H |
| HT2-5 | 1 | 1 | 4-CH₃ | 4-CH₃ | 4-CH₃ | H | H | H |
| HT2-6 | 0 | 1 | H | H | H | H | H | H |
| HT2-7 | 0 | 1 | 4-CH₃ | 4-CH₃ | 4-CH₃ | 4-CH₃ | 4-CH₃ | 4-CH₃ |
| HT2-8 | 0 | 1 | 4-CH₃ | 4-CH₃ | H | H | 4-CH₃ | 4-CH₃ |
| HT2-9 | 0 | 1 | H | H | 4-CH₃ | 4-CH₃ | H | H |
| HT2-10 | 0 | 1 | H | H | 3-CH₃ | 3-CH₃ | H | H |
| HT2-11 | 0 | 1 | 4-CH₃ | H | H | H | 4-CH₃ | H |
| HT2-12 | 0 | 1 | 4-OCH₃ | H | H | H | 4-OCH₃ | H |
| HT2-13 | 0 | 1 | H | H | 4-OCH₃ | 4-OCH₃ | H | H |
| HT2-14 | 0 | 1 | 4-OCH₃ | H | 4-OCH₃ | H | 4-OCH₃ | 4-OCH₃ |
| HT2-15 | 0 | 1 | 3-CH₃ | H | 3-CH₃ | H | 3-CH₃ | H |
| HT2-16 | 1 | 1 | 4-CH₃ | 4-CH₃ | 4-CH₃ | 4-CH₃ | 4-CH₃ | 4-CH₃ |
| HT2-17 | 1 | 1 | 4-CH₃ | 4-CH₃ | H | H | 4-CH₃ | 4-CH₃ |
| HT2-18 | 1 | 1 | H | H | 4-CH₃ | 4-CH₃ | H | H |
| HT2-19 | 1 | 1 | H | H | 3-CH₃ | 3-CH₃ | H | H |
| HT2-20 | 1 | 1 | 4-CH₃ | H | H | H | 4-CH₃ | H |
| HT2-21 | 1 | 1 | 4-OCH₃ | H | H | H | 4-OCH₃ | H |
| HT2-22 | 1 | 1 | H | H | 4-OCH₃ | 4-OCH₃ | H | H |
| HT2-23 | 1 | 1 | 4-OCH₃ | H | 4-OCH₃ | H | 4-OCH₃ | 4-OCH₃ |
| HT2-24 | 1 | 1 | 3-CH₃ | H | 3-CH₃ | H | 3-CH₃ | H |

The abbreviations used for describing the above exemplified compounds stand for the following. The numbers attached to the substituent groups each refer to the position at which the substituent group is bonded to a benzene ring.
CH₃: Methyl group
OCH₃: Methoxy group

Only one type of the butadiene-based hole transporting material (HT2) may be used alone. Alternatively, two or more types of the butadiene-based hole transporting materials (HT2) may be used in combination.

The content of the hole transporting material may be, for example, 10% by weight or more and 98% by weight or less, is desirably 60% by weight or more and 95% by weight or less, and is more desirably 70% by weight or more and 90% by weight or less of the amount of binder resin.

Electron Transporting Material Examples of the electron transporting material include, but are not limited to, quinones such as chloranil and bromanil; tetracyanoquinodimethane-based compounds; fluorenones such as 2,4,7-trinitrofluorenone, 9-dicyanomethylene-9-fluorenone-4-octyl carboxylate, and 2,4,5,7-tetranitro-9-fluorenone; oxadiazoles such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthones; thiophenes; dinaphthoquinones such as 3,3′-di-tert-pentyl-dinaphthoquinone; diphenoquinones such as 3,3′-di-tert-butyl-5,5′-dimethyldiphenoquinone and 3,3′,5,5′-tetra-tert-butyl-4,4′-diphenoquinone; and polymers including a backbone or a side chain that is a group constituted by the above compounds. The above electron transporting materials may be used alone or in combination of two or more.

Among the above electron transporting materials, in particular, the fluorenone-based electron transporting material represented by General Formula (ET1) below and the diphenoquinone-based electron transporting material represented by General Formula (ET2) below may be used.

The fluorenone-based electron transporting material represented by General Formula (ET1) is described below.

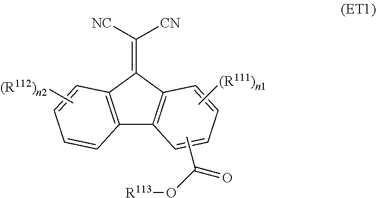

In General Formula (ET1) above, R¹¹¹ and R¹¹² each independently represent a halogen atom, an alkyl group, an alkoxy group, an aryl group, or an aralkyl group; R¹¹³ represents an alkyl group, a -L¹¹⁴-O—R¹¹⁵ group, an aryl group, or an aralkyl group, where L¹¹⁴ is an alkylene group and R¹¹⁵ is an alkyl group; and n1 and n2 each independently represent an integer of 0 to 3.

Examples of the halogen atom represented by R¹¹¹ and R¹¹² in General Formula (ET1) include a fluorine atom, a chlorine atom, a bromine atom, and an iodine atom.

Examples of the alkyl group represented by R¹¹¹ and R¹¹² in General Formula (ET1) include linear and branched alkyl groups having 1 to 4 carbon atoms and preferably 1 to 3 carbon atoms. Specific examples of such alkyl groups include a methyl group, an ethyl group, an n-propyl group, an isopropyl group, an n-butyl group, an isobutyl group, and a tert-butyl group.

Examples of the alkoxy group represented by R¹¹¹ and R¹¹² in General Formula (ET1) include alkoxy groups having 1 to 4 carbon atoms and preferably 1 to 3 carbon atoms. Specific examples of such alkoxy groups include a methoxy group, an ethoxy group, a propoxy group, and a butoxy group.

Examples of the aryl group represented by R¹¹¹ and R¹¹² in General Formula (ET1) include a phenyl group and a tolyl group.

Examples of the aralkyl group represented by R¹¹¹ and R¹¹² in General Formula (ET1) include a benzyl group, a phenethyl group, and a phenylpropyl group.

Among the above groups represented by R¹¹¹ and R¹¹² in General Formula (ET1), in particular, a phenyl group may be used.

Examples of the alkyl group represented by R¹¹³ in General Formula (ET1) include linear alkyl groups having 1 to 15 carbon atoms and preferably 5 to 10 carbon atoms and branched alkyl groups having 3 to 15 carbon atoms and preferably 5 to 10 carbon atoms.

Examples of the linear alkyl groups having 1 to 15 carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, and an n-pentadecyl group.

Examples of the branched alkyl groups having 3 to 15 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isoundecyl group, a sec-undecyl group, a tert-undecyl group, an isododecyl group, a sec-dodecyl group, a tert-dodecyl group, an isotridecyl group, a sec-tridecyl group, a tert-tridecyl group, an isotetradecyl group, a sec-tetradecyl group, a tert-tetradecyl group, an isopentadecyl group, a sec-pentadecyl group, and a tert-pentadecyl group.

In the -L¹¹⁴-O—R¹¹⁵ group represented by R¹¹³ in General Formula (ET1), L¹¹⁴ represents an alkylene group and R¹¹⁵ represents an alkyl group.

Examples of the alkylene group represented by L¹¹⁴ include linear and branched alkylene groups having 1 to 12 carbon atoms, such as a methylene group, an ethylene group, an n-propylene group, an isopropylene group, an n-butylene group, an isobutylene group, a sec-butylene group, a tert-butylene group, an n-pentylene group, an isopentylene group, a neopentylene group, and a tert-pentylene group.

Examples of the alkyl group represented by R¹¹⁵ are the same as the above-described examples of the alkyl group represented by R¹¹¹ and R¹¹².

Examples of the aryl group represented by R¹¹³ in General Formula (ET1) include a phenyl group, a methylphenyl group, and a dimethylphenyl group.

In the case when R¹¹³ in General Formula (ET1) represents an aryl group, the aryl group may include an alkyl substituent group from the viewpoint of solubility. Examples of the alkyl group that can be included as a substituent group in the aryl group are the same as the above-described examples of the alkyl group represented by R¹¹¹ and R¹¹². Specific examples of the aryl group including an alkyl substituent group include a methylphenyl group, a dimethylphenyl group, and an ethylphenyl group.

An example of the aralkyl group represented by R¹¹³ in General Formula (ET1) is a —R¹¹⁶—Ar group, where R¹¹⁶ represents an alkylene group and Ar represents an aryl group.

Examples of the alkylene group represented by R¹¹⁶ include linear and branched alkylene groups having 1 to 12 carbon atoms, such as a methylene group, an ethylene group, an n-propylene group, an isopropylene group, an n-butylene group, an isobutylene group, a sec-butylene group, a tert-butylene group, an n-pentylene group, an isopentylene group, a neopentylene group, and a tert-pentylene group.

Examples of the aryl group represented by Ar include a phenyl group, a methylphenyl group, an ethylphenyl group, and a dimethylphenyl group.

Specific examples of the aralkyl group represented by R¹¹³ in General Formula (ET1) include a benzyl group, a methylbenzyl group, a dimethylbenzyl group, a phenylethyl group, a methylphenylethyl group, an ethylphenylethyl group, a phenylpropyl group, and a phenylbutyl group.

In the fluorenone-based electron transporting material represented by General Formula (ET1), in particular, it is preferable that R¹¹³ represents an aralkyl group or a branched alkyl group having 5 to 10 carbon atoms in order to, for example, enhance sensitivity. More preferably, R¹¹¹ and R¹¹² each independently represent a halogen atom or an alkyl group and R¹¹³ represents an aralkyl group or a branched alkyl group having 5 to 10 carbon atoms. For the same purpose, the —CO(═O)—R¹¹³ group is further preferably attached to the 2- or 4-position and is particularly preferably attached to the 4-position.

Only one type of the fluorenone-based electron transporting material represented by General Formula (ET1) may be used alone. Alternatively, two or more types of the fluorenone-based electron transporting materials represented by General Formula (ET1) may be used in combination.

Examples of the fluorenone-based electron transporting material represented by General Formula (ET1) include, but are not limited to, the following exemplified compounds. Hereinafter, the exemplified compounds are numbered “exemplified compound (ET1-[Number])”, such as “exemplified compound (ET1-2)”.

| Exemplified | | | | | | |
|---|---|---|---|---|---|---|
| compound | n1 | n2 | R¹¹¹ | R¹¹² | —CO(═O)—R¹¹³ | R¹¹³ |
| ET1-1 | 0 | 0 | — | — | 4-CO(═O)—R¹¹³ | -n-C₇H₁₅ |
| ET1-2 | 0 | 0 | — | — | 4-CO(═O)—R¹¹³ | -n-C₈H₁₇ |
| ET1-3 | 0 | 0 | — | — | 4-CO(═O)—R¹¹³ | -n-C₅H₁₁ |
| ET1-4 | 0 | 0 | — | — | 4-CO(═O)—R¹¹³ | -n-C₁₀H₂₁ |
| ET1-5 | 3 | 4 | 1 to 3-Cl | 1 to 3-Cl | 4-CO(═O)—R¹¹³ | -n-C₇H₁₅ |
| ET1-6 | 2 | 2 | 1-Cl | 5-Cl | 4-CO(═O)—R¹¹³ | -n-C₇H₁₅ |
| | | | 2-Cl | 7-Cl | | |
| ET1-7 | 3 | 4 | 1 to 3-CH₃ | 5 to 8-CH₃ | 4-CO(═O)—R¹¹³ | -n-C₇H₁₅ |
| ET1-8 | 3 | 4 | 1 to 3-C₄H₉ | 5 to 8-C₄H₉ | 4-CO(═O)—R¹¹³ | -n-C₇H₁₅ |
| ET1-9 | 2 | 2 | 1-CH₃O | 6-CH₃O | 4-CO(═O)—R¹¹³ | -n-C₈H₁₇ |
| | | | 3-CH₃O | 8-CH₃O | | |
| ET1-10 | 3 | 4 | 1 to 3-C₆H₅ | 5 to 8-C₆H₅ | 4-CO(═O)—R¹¹³ | -n-C₈H₁₇ |
| ET1-11 | 0 | 0 | — | — | 4-CO(═O)—R¹¹³ | -n-C₄H₉ |
| ET1-12 | 0 | 0 | — | — | 4-CO(═O)—R¹¹³ | -n-C₁₁H₂₃ |
| ET1-13 | 0 | 0 | — | — | 4-CO(═O)—R¹¹³ | -n-C₉H₁₉ |
| ET1-14 | 0 | 0 | — | — | 4-CO(═O)—R¹¹³ | —CH₂—CH(C₂H₅)—C₄H₉ |
| ET1-15 | 0 | 0 | — | — | 4-CO(═O)—R¹¹³ | —(CH₂)₂—Ph |
| ET1-16 | 0 | 0 | — | — | 4-CO(═O)—R¹¹³ | —CH₂—Ph |
| ET1-17 | 0 | 0 | — | — | 4-CO(═O)—R¹¹³ | -n-C₁₂H₂₅ |
| ET1-18 | 0 | 0 | — | — | 4-CO(═O)—R¹¹³ | —C₂H₄—O—CH₃ |
| ET1-19 | 0 | 0 | — | — | 2-CO(═O)—R¹¹³ | —CH₂—Ph |

The abbreviations used for describing the above-described exemplified compounds stand for the following.

The symbol “[Number]-” attached in front of a substituent group refers to the position at which the substituent group is attached to a fluorene ring. For example, the symbol “1-Cl” refers to a chlorine (Cl) atom attached to the 1-position of a fluorene ring. The symbol “4-CO(═O)—R¹¹³” refers to a —CO(═O)—R¹¹³ group attached to the 4-position of a fluorene ring.

The symbol “1-to-3-” attached in front of a substituent group means that the substituent group is attached to all of the 1- to 3-positions of a fluorene ring. The symbol of “5-to-8-” attached in front of the symbol of a substituent group means that the substituent group is attached to all of the 5- to 8-positions of a fluorene ring.

The symbol “Ph” refers to a phenyl group.

The diphenoquinone-based electron transporting material represented by General Formula (ET2) is described below.

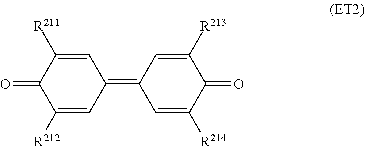

In General Formula (ET2), R²¹¹, R²¹², R²¹³, and R²¹⁴ each independently represent a hydrogen atom, an alkyl group, an alkoxy group, a halogen atom, or a phenyl group.

Examples of the alkyl group represented by R²¹¹ to R²¹⁴ in General Formula (ET2) include linear and branched alkyl groups having 1 to 6 carbon atoms. Specific examples thereof include a methyl group, an ethyl group, an n-propyl group, an isopropyl group, an n-butyl group, an isobutyl group, a tert-butyl group, a pentyl group, and a hexyl group.

The alkyl groups represented by R²¹¹ to R²¹⁴ may include a substituent group. Examples of the substituent group that may be included in the alkyl groups include a cycloalkyl group and a fluorine-substituted alkyl group.

Examples of the alkoxy group represented by R²¹¹ to R²¹⁴ in General Formula (ET2) include alkoxy groups having 1 to 6 carbon atoms. Specific examples thereof include a methoxy group, an ethoxy group, a propoxy group, and a butoxy group.

Examples of the halogen atom represented by R²¹¹ to R²¹⁴ in General Formula (ET2) include a chlorine atom, an iodine atom, a bromine atom, and a fluorine atom.

The phenyl group represented by R²¹¹ to R²¹⁴ in General Formula (ET2) may include a substituent group. Examples of the substituent group that may be included in the phenyl group include an alkyl group having, for example, 1 to 6 carbon atoms, an alkoxy group having, for example, 1 to 6 carbon atoms, and a biphenyl group.

Only one type of the diphenoquinone-based electron transporting material represented by General Formula (ET2) may be used alone. Alternatively, two or more types of the diphenoquinone-based electron transporting material represented by General Formula (ET2) may be used in combination.

Examples of the diphenoquinone-based electron transporting material represented by General Formula (ET2) include, but are not limited to, the following exemplified compounds. Hereinafter, the exemplified compounds are numbered “exemplified compound (ET2-[Number])”, such as “exemplified compound (ET2-2)”.

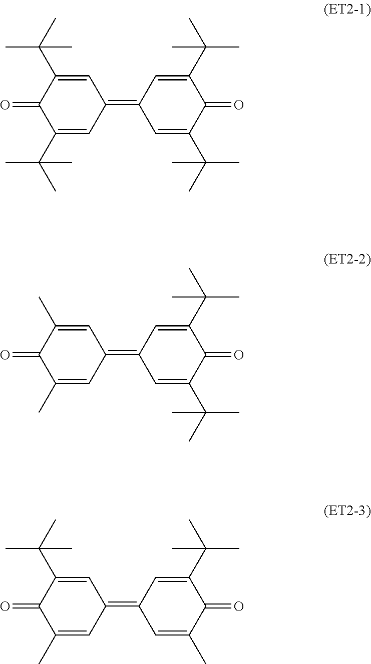

The content of the electron transporting material may be, for example, 4% by weight or more and 70% by weight or less, is desirably 8% by weight or more and 50% by weight or less, and is more desirably 10% by weight or more and 30% by weight or less of the amount of binder resin.

Weight Ratio Between Hole Transporting Material and Electron Transporting Material

The wright ratio between the hole transporting material and the electron transporting material, that is, [hole transporting material]/[electron transporting material], is desirably 50/50 or more and 90/10 or less and is more desirably 60/40 or more and 80/20 or less.

Other Additives

The single-layer photosensitive layer may include other known additives such as an antioxidant, a photostabilizer, and a heat stabilizer. In the case where the single-layer photosensitive layer serves as a surface layer (i.e., protection layer), the photosensitive layer may include fluorine resin particles, silicone oil, and the like.

### Formation of Single-Layer Photosensitive Layer

The single-layer photosensitive layer is formed using a photosensitive-layer forming coating liquid, which is prepared by mixing the above-described photosensitive layer components (e.g., the charge generating material, the hole transporting material, the electron transporting material, and the binder resin) with a solvent and, as needed, additives such as a dispersing aid. Specifically, the photosensitive-layer forming coating liquid is applied to, for example, the conductive support or the undercoat layer, and the coating liquid (i.e., coating film) deposited on the conductive support or the undercoat layer is dried to form a photosensitive layer. The photosensitive-layer forming coating liquid may be prepared by mixing the above-described photosensitive layer components with a solvent at a time or by mixing together solutions each prepared by mixing at least one photosensitive layer component with a solvent.

The photosensitive layer according to this exemplary embodiment has a Martens hardness Hm of 170 N/mm² or more and 200 N/mm² or less. The Martens hardness Hm of the photosensitive layer can be controlled to fall within the above range by setting the temperature at which the photosensitive-layer forming coating liquid (i.e., coating film) deposited on the conductive support or the undercoat layer is dried to be lower than the ordinary drying temperature.

For example, the drying temperature is preferably set to 100° C. or more and 140° C. or less, is more preferably set to 120° C. or more and 138° C. or less, and is further preferably set to 125° C. or more and 135° C. or less.

The amount of time during which drying is performed may also be controlled as well as the drying temperature. For example, the amount of drying time is preferably set to 15 minutes or more and 40 minutes or less, is more preferably set to 20 minutes or more and 35 minutes or less, and is further preferably set to 22 minutes or more and 25 minutes or less.

Drying the photosensitive-layer forming coating liquid deposited on the conductive support or the undercoat layer at a drying temperature that falls within the above range (preferably, at a drying temperature that falls within the above range for an amount of drying time that falls within the above range) increases the residual solvent content in the photosensitive layer to an adequate level. Specifically, it becomes easy to control the residual solvent content to be 0.04% by weight or more and 1.6% by weight or less (preferably, 0.5% by weight or more and 1.3% by weight or less; and more preferably, 0.8% by weight or more and 1.1% by weight or less) of the total weight of the photosensitive layer.

It is considered that this reduces the degree at which the resins included in the photosensitive layer adhere to one another, the hardness of the surface of the photoreceptor (in this exemplary embodiment, the photosensitive layer) is consequently reduced, and the abrasion of the surface of the photoreceptor is increased. As a result, ease of removal of foreign matter present in the surface of the photoreceptor may be readily increased.

In the photoreceptor according to this exemplary embodiment, a specific phthalocyanine pigment that serves as a charge generating material is added to the photosensitive layer in order to maintain the originally required functions (i.e., high chargeability and a capability of forming images having a high density) of the photoreceptor even when the Martens hardness Hm of the photosensitive layer is reduced to 170 N/mm².

The charge generating ability of the above-described charge generating material may be readily enhanced by performing a manipulation for enhancing the dispersibility of the charge generating material in the preparation of the photosensitive-layer forming coating liquid. An example of the manipulation for enhancing the dispersibility of the charge generating material is a method in which the charge generating material is premixed. In this method, in the preparation of the photosensitive-layer forming coating liquid, a solution is prepared by dispersing the charge generating material in a solvent (hereinafter, this solution is referred to as “charge generating material dispersion”) and the charge generating material dispersion is added to the photosensitive-layer forming coating liquid. For dispersing the charge generating material in a solvent, dispersing equipment may be used.

Examples of the dispersing equipment include media dispersing machines such as a ball mill, a vibrating ball mill, an Attritor, a sand mill, and a horizontal sand mill; and medialess dispersing machines such as a stirrer, an ultrasonic wave disperser, a roll mill, a high-pressure homogenizer (e.g., collision type and penetration type), an ultrasonic wave homogenizer, and a Nanomizer. Among the above dispersing equipment, in particular, an ultrasonic wave homogenizer, a Nanomizer, and an ultrasonic wave disperser may be used in order to enhance the dispersibility of the charge generating material.

In order to further enhance the dispersibility of the charge generating material, a dispersing aid such as an amine compound may be used in the preparation of the charge generating material dispersion. In addition, after the charge generating material dispersion has been added to the photosensitive-layer forming coating liquid, the charge generating material may be dispersed together with the other photosensitive layer components (e.g., the hole transporting material, the electron transporting material, and the binder resin) included in the photosensitive-layer forming coating liquid. For dispersing the charge generating material together with the other photosensitive layer components, for example, the above described dispersing equipment may be used. In particular, a Nanomizer may be used in order to further enhance the dispersibility of the charge generating material.

Performing the above-described manipulation enhances the dispersibility of the charge generating material in the photosensitive-layer forming coating liquid. Therefore, when a photosensitive layer is formed using the photosensitive-layer forming coating liquid, the charge generating material is dispersed substantially homogeneously in the photosensitive layer. This enables the charge generating ability of the charge generating material to be readily enhanced. As a result, a photoreceptor having high chargeability and capable of forming images having a high density may be readily produced even when the hardness of the photosensitive layer is reduced.

Examples of the solvent include the following common organic solvents: aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic and linear ethers such as tetrahydrofuran and ethyl ether. The above solvents may be used alone or in a mixture of two or more.

For applying the photosensitive-layer forming coating liquid prepared by the above-described manipulation to the conductive substrate, the undercoat layer, or the like, for example, dip coating, push coating, wire bar coating, spray coating, blade coating, knife coating, and curtain coating may be employed.

### Image Forming Apparatus and Process Cartridge

An image forming apparatus according to an exemplary embodiment includes an electrophotographic photoreceptor, a charging unit that charges the surface of the electrophotographic photoreceptor, an electrostatic-latent-image forming unit that forms an electrostatic latent image on the charged surface of the electrophotographic photoreceptor, a developing unit that develops the electrostatic latent image formed on the surface of the electrophotographic photoreceptor with a developer including a toner in order to form a toner image, and a transfer unit that transfers the toner image onto the surface of a recording medium. The electrophotographic photoreceptor is the electrophotographic photoreceptor according to the above-described exemplary embodiment.

The image forming apparatus according to this exemplary embodiment may be implemented as any of the following known image forming apparatuses: an image forming apparatus that includes a fixing unit that fixes a toner image transferred onto the surface of a recording medium; a direct-transfer image forming apparatus that directly transfers a toner image formed on the surface of an electrophotographic photoreceptor onto the surface of a recording medium; an intermediate-transfer image forming apparatus that transfers a toner image formed on the surface of an electrophotographic photoreceptor onto the surface of an intermediate transfer body (this process is referred to as “first transfer”) and further transfers the toner image transferred onto the surface of the intermediate transfer body onto the surface of a recording medium (this process is referred to as “second transfer”); an image forming apparatus that includes a cleaning unit that cleans the surface of an electrophotographic photoreceptor which has not yet been charged after a toner image has been transferred; an image forming apparatus that includes a charge eliminating unit that irradiates, with charge elimination light, the surface of an electrophotographic photoreceptor which has not yet been charged after a toner image has been transferred in order to eliminate charge; and an image forming apparatus that includes an electrophotographic-photoreceptor heating member that heats an electrophotographic photoreceptor in order to lower the relative temperature of the electrophotographic photoreceptor.

In the intermediate-transfer image forming apparatus, the transfer unit includes, for example, an intermediate transfer body onto which a toner image is transferred, a first transfer unit that transfers a toner image formed on the surface of an electrophotographic photoreceptor onto the surface of the intermediate transfer body (first transfer), and a second transfer unit that transfers the toner image transferred onto the surface of the intermediate transfer body onto the surface of a recording medium (second transfer).

The image forming apparatus according to this exemplary embodiment may be a dry-developing image forming apparatus or a wet-developing image forming apparatus, which develops images with a liquid developer.

In the image forming apparatus according to this exemplary embodiment, for example, a portion including the electrophotographic photoreceptor may have a cartridge structure, that is, may be a process cartridge, which is detachably attachable to the image forming apparatus. The process cartridge may include, for example, the electrophotographic photoreceptor according to the above-described exemplary embodiment. The process cartridge may further include, for example, at least one component selected from the group consisting of a charging unit, an electrostatic-latent-image forming unit, a developing unit, and a transfer unit.

An example of the image forming apparatus according to this exemplary embodiment is described below. However, the image forming apparatus according to this exemplary embodiment is not limited to this. Hereinafter, only the components illustrated in the drawings are described, and the descriptions of the other components are omitted.

FIG. 2 schematically illustrates an example of the image forming apparatus according to this exemplary embodiment.

As illustrated in FIG. 2, an image forming apparatus 100 according to this exemplary embodiment includes a process cartridge 300 including an electrophotographic photoreceptor 7, an exposure device 9 (an example of the electrostatic-latent-image forming unit), a transfer device 40 (i.e., first transfer device), and an intermediate transfer body 50. In the image forming apparatus 100, the exposure device 9 is arranged such that the electrophotographic photoreceptor 7 is exposed to light emitted by the exposure device 9 through an aperture formed in the process cartridge 300; the transfer device 40 is arranged so as to face the electrophotographic photoreceptor 7 with the intermediate transfer body 50 interposed therebetween; and the intermediate transfer body 50 is arranged such that part of the intermediate transfer body 50 comes into contact with the electrophotographic photoreceptor 7. Although not illustrated in the drawing, the image forming apparatus 100 also includes a second transfer device that transfers a toner image transferred to the intermediate transfer body 50 to a recording medium such as paper. In the image forming apparatus 100, the intermediate transfer body 50, the transfer device 40 (i.e., first transfer device), and the second transfer device (not shown) correspond to an example of the transfer unit.

The process cartridge 300 illustrated in FIG. 2 includes the electrophotographic photoreceptor 7, a charging device 8 (an example of the charging unit), a developing device 11 (an example of the developing unit), and a cleaning device 13 (an example of the cleaning unit), which are integrally supported inside a housing. The cleaning device 13 includes a cleaning blade 131 (an example of the cleaning member), which is arranged to come into contact with the surface of the electrophotographic photoreceptor 7. The form of the cleaning member is not limited to the cleaning blade 131 and may be, for example, a conductive or insulating fibrous member. The conductive or insulating fibrous member may be used alone or in combination with the cleaning blade 131.

The image forming apparatus illustrated in FIG. 2 includes a roller-like, fibrous member 132 with which a lubricant 14 is fed onto the surface of the electrophotographic photoreceptor 7 and a flat-brush-like, fibrous member 133 that assists cleaning. However, the image forming apparatus illustrated in FIG. 2 is merely an example, and the cleaning members 132 and 133 are optional.

The components of the image forming apparatus according to this exemplary embodiment are each described below.

### Charging Device

The charging device 8 may be, for example, a contact charger including a conductive or semiconductive charging roller, charging brush, charging film, charging rubber blade, charging tube, or the like. Known chargers such as a noncontact roller charger and a scorotron and corotron that utilize corona discharge may also be used.

### Exposure Device

The exposure device 9 may be, for example, an optical device with which the surface of the electrophotographic photoreceptor 7 can be exposed to light emitted by a semiconductor laser, an LED, a liquid-crystal shutter, or the like in a predetermined image pattern. The wavelength of the light source is set to fall within the range of the spectral sensitivity of the electrophotographic photoreceptor. Although common semiconductor lasers have an oscillation wavelength in the vicinity of 780 nm, that is, the near-infrared region, a semiconductor laser that may be used as a light source is not limited to such semiconductor lasers; semiconductor lasers having an oscillation wavelength of about 600 to 700 nm and blue semiconductor lasers having an oscillation wavelength of 400 nm or more and 450 nm or less may also be used. For forming color images, surface-emitting lasers capable of emitting multi beam may be used as a light source.

### Developing Device

The developing device 11 may be, for example, a common developing device that develops latent images with a developer in a contacting or noncontacting manner. The type of the developing device 11 is not limited and may be selected depending on the purpose. Examples of the developing device include known developing devices capable of depositing a one- or two-component developer on an electrophotographic photoreceptor 7 with a brush, a roller, or the like. In particular, a developing device including a developing roller on which a developer is deposited may be used.

The developer included in the developing device 11 may be a one-component developer containing only a toner or a two-component developer containing a toner and a carrier. The developer may be magnetic or nonmagnetic. Known developers may be used as a developer included in the developing device 11.

### Cleaning Device

The cleaning device 13 may be, for example, a cleaning-blade-type cleaning device including a cleaning blade 131.

The type of the cleaning device 13 is not limited to the cleaning-blade-type cleaning device, and a fur-brush-cleaning-type cleaning device and a cleaning device that performs cleaning and development at the same time may also be used.

### Transfer Device

The transfer device 40 may be, for example, any of the following known transfer chargers: contact transfer chargers including a belt, a roller, a film, a rubber blade, or the like; and transfer chargers such as a scorotron and a corotron which utilize corona discharge.

### Intermediate Transfer Body

The intermediate transfer body 50 may be, for example, a belt-like intermediate transfer body, that is, an intermediate transfer belt, including polyimide, polyamideimide, polycarbonate, polyarylate, polyester, a rubber, or the like that is made semiconductive. The intermediate transfer body is not limited to a belt-like intermediate transfer body and may be a drum-like intermediate transfer body.

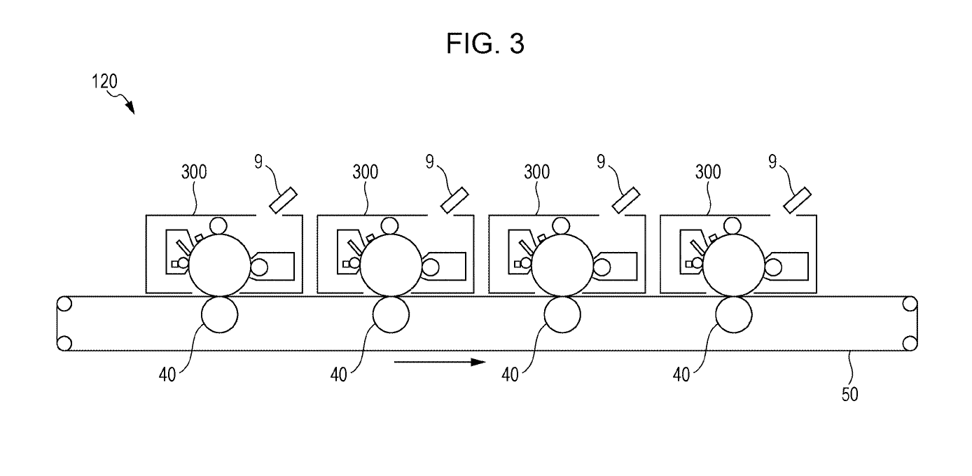

FIG. 3 schematically illustrates another example of the image forming apparatus according to this exemplary embodiment.

An image forming apparatus 120 illustrated in FIG. 3 is a tandem, multi-color image forming apparatus including four process cartridges 300. In the image forming apparatus 120, the four process cartridges 300 are arranged in parallel to one another on an intermediate transfer body 50, and one electrophotographic photoreceptor is used for one color. The image forming apparatus 120 has the same structure as that of the image forming apparatus 100 except that the image forming apparatus 120 is tandem.

### EXAMPLES

The above-described exemplary embodiments are described in detail with reference to Examples below. However, the foregoing exemplary embodiments are not limited by Examples below. Hereinafter, all “part” and “%” are on a weight basis unless otherwise specified.

### Example 1

### Preparation of Photoreceptor (1)

A solution containing 1.5 parts of charge generating materials which are a hydroxygallium phthalocyanine pigment (CG1) and a chlorogallium phthalocyanine pigment (CG2) such that the weight ratio CG1:CG2 is 3:7, 0.2 parts of an amine that served as a dispersing aid, and 13 parts of tetrahydrofuran that served as a solvent is prepared. The hydroxygallium phthalocyanine pigment (CG1) is a V-Type hydroxygallium phthalocyanine pigment having diffraction peaks at, at least, Bragg angles (2θ±0.2°) of 7.3°, 16.0°, 24.9°, and 28.0° in an X-ray diffraction spectrum measured with the CuKα radiation. The chlorogallium phthalocyanine pigment (CG2) is a chlorogallium phthalocyanine pigment having diffraction peaks at, at least, Bragg angles (2θ±) 0.2° of 7.4°, 16.6°, 25.5°, and 28.3° in an X-ray diffraction spectrum measured with the CuKα radiation. The solution is stirred with a magnetic stirrer for 20 hours and subsequently further stirred with an ultrasonic wave homogenizer for 4 hours until the charge generating materials are dispersed substantially homogeneously. Thus, a dispersion (1) is prepared.

A solution containing 4 parts of an electron transporting material (ET1A), 12 parts of a hole transporting material (HT1A), 22 parts of a hole transporting material (HT2A), 60 parts of bisphenol-Z polycarbonate (viscosity-average molecular weight: 45,000) that served as a binder resin, and 77 parts of tetrahydrofuran and 10 parts of toluene that served as solvents, is prepared. The solution is stirred with a universal ball mill until the binder resin is dissolved in the solution. Thus, a dispersion (2) is prepared.

The dispersions (1) and (2) are mixed with each other, and the resulting mixture is stirred with a universal ball mill until the two dispersions are mixed with each other substantially homogeneously. Thus, a coating liquid is prepared.

The coating liquid is subjected to a Nanomizer six times such that the charge generating materials are dispersed substantially homogeneously. Thus, a photosensitive-layer forming coating liquid is prepared.

A single-layer photoreceptor (1) is prepared by forming a photosensitive layer with the photosensitive-layer forming coating liquid in the following manner.

The photosensitive-layer forming coating liquid is deposited on a conductive substrate that is an aluminium substrate (i.e., aluminium cut pipe) having an outside diameter of 30 mm, a length of 245 mm, and a thickness of 0.75 mm by dip coating. Specifically, while the coating liquid is circulated at a flow rate of 13 L/min, the aluminium substrate is dipped into the coating liquid in the environment of 27.5° C. and 20% RH in order to form a coating film on the aluminium substrate. The velocity at which the aluminium substrate is made to enter the coating liquid is set to 1,500 mm/min.

The coating film formed on the aluminium substrate is dried and made to cure under the following drying conditions (i.e., dry-curing conditions): drying temperature: 135° C.; humidity: 1% RH; amount of drying time: 24 minutes.

Thus, a photosensitive layer having a thickness of 22 μm is formed on the aluminium substrate. The single-layer photoreceptor (1) is prepared in the above-described manner.

### Examples 2 to 7 and Comparative Examples 1 to 8

Photoreceptors (2) to (7) and (C1) to (C8) are prepared as in the preparation of photoreceptor (1) in Example 1, except that, in the composition of the photosensitive-layer forming coating liquid, the types and contents of the charge generating materials, the electron transporting material, and the hole transporting material and the temperature at which the deposited coating liquid is dried are changed as described in Tables 1 and 2. Note that, in Comparative Example 8, only 1.5 parts of a titanyl phthalocyanine pigment (CG3) is used as a charge generating material.

### Evaluations

### Martens Hardness Hm

The Martens hardness Hm of the photosensitive layer included in each of the photoreceptors prepared in Examples and Comparative examples is measured by the above-described method. Tables 1 and 2 summarize the results.

### Content of Residual Solvent

A sample piece having a weight of 2 mg is cut from the photosensitive layer included in each of the photoreceptors prepared in Examples and Comparative examples. The residual solvent content in the photosensitive layer (i.e., the content of tetrahydrofuran and toluene that remained in the photosensitive layer) is determined using this sample by the above-described method. Tables 1 and 2 summarize the results.

### Ease of Removal of Foreign Matter

The photoreceptors prepared in Examples and Comparative Examples are each attached to an image forming apparatus “HL-2240D” produced by Brother Industries, Ltd. A solid, white image is printed on three A4-size sheets by using each of the image forming apparatuses in the environment of 30° C. and 85% RH. The solid white images printed on the third sheets are each inspected for occurrence of image defects (i.e., black dots), and the surface of the photoreceptor is inspected with an optical microscope at positions corresponding to the positions of the image defects (i.e., black dots). In the inspection of the surface of the photoreceptor, the number of pieces of foreign matter buried in the surface of the photoreceptor, that is, the photosensitive layer, (hereinafter, this number is referred to as “number of buried foreign matter pieces”) is counted. The ease of removal of foreign matter present in each of the photoreceptors is evaluated on the basis of the number of buried foreign matter pieces in accordance with the following criteria. Tables 1 and 2 summarize the results.

Note that, in the following evaluation criteria, the “number of buried foreign matter pieces” denotes not only the number of pieces of foreign matter buried in the surface of the photoreceptor but also the number of pieces of foreign matter lodged in the surface of the photoreceptor.

Evaluation Criteria

G1: Number of Buried Foreign Matter Pieces≦2

G2: 2<Number of Buried Foreign Matter Pieces≦4

G3: 4<Number of Buried Foreign Matter Pieces≦6

G4: 6<Number of Buried Foreign Matter Pieces

### Image Density

The photoreceptors prepared in Examples and Comparative Examples are each attached to the above image forming apparatus. A solid, black image having a density of 100% is printed on three A4-size sheets with each of the image forming apparatuses in the environment of 30° C. and 85% RH. The densities of the solid, black images printed on the third sheets are measured with a densitometer “X-Rite 967” produced by X-Rite, Inc. and evaluated in accordance with the following criteria. Tables 1 and 2 summarize the results.

Evaluation Criteria

G1: cin1.4≦Density of Solid Black Image

G2: cin1.3≦Density of Solid Black Image<cin1.4

G3: Density of Solid Black Image<cin1.3

### Chargeability

The photoreceptors prepared in Examples and Comparative Examples are each attached to an image forming apparatus “HL-2240D” (noncontact charge type) produced by Brother Industries, Ltd. The image forming apparatus is modified such that the potential of the photoreceptor can be measured. Specifically, the developing device of the image forming apparatus is replaced with a surface-potential measuring probe “Model 555P-1” produced by TREK, Inc., which is arranged to face the photoreceptor. The probe is connected to a surface electrometer “TREK334” produced by TREK, Inc.

Subsequently, a voltage of +600 V is applied to the charging device in a high-temperature, high-humidity (28° C., 85% RH) environment in order to charge the photoreceptor. The surface potential of the photoreceptor is measured. The measurement of surface potential is made all over the surface of the photoreceptor. Hereinafter, the measured surface potential of the photoreceptor is referred to as “photoreceptor surface potential VH”. The chargeability of each of the photoreceptors is evaluated on the basis of photoreceptor surface potential VH in accordance with the following criteria. Tables 1 and 2 summarize the results.

Evaluation Standard

G1: 560 V≦Photoreceptor Surface Potential VH≦640 V

G2: 550 V≦Photoreceptor Surface Potential VH<560 V, or 640 V<Photoreceptor Surface Potential VH≦650 V

G3: Photoreceptor Surface Potential VH<550 V, or 650 V<Photoreceptor Surface Potential VH

TABLE 1

| | | Photosensitive layer | | | | | | | | | | |
|---|---|---|---|---|---|---|---|---|---|---|---|---|
| | | Charge generating | | Electron | | | | | | Evaluations | | |
| | | material | | transporting | Hole transporting | | Content of | | | | Ease of | |
| | Type of | | Type | material | material | | residual | Martens | Drying | | removal of | |
| | photo- | | Weight | Type | Type | Type | solvent | hardness | temperature | Charge- | foreign | Image |
| | receptor | Parts | ratio | Parts | Parts | Parts | [weight %] | [N/cm²] | [° C.] | ability | matter | density |
| Example | (1) | 1.5 | CG1:CG2 | ET1A | HT1A | HT2A | 0.05 | 185 | 133 | G1 | G1 | G1 |
| 1 | | | 3:7 | 4 Parts | 12 Parts | 22 Parts | | | | | | |
| Example | (2) | 1.5 | CG1:CG2 | ET1A | HT1A | HT2A | 1.01 | 180 | 115 | G1 | G1 | G1 |
| 2 | | | 3:7 | 4 Parts | 12 Parts | 22 Parts | | | | | | |
| Example | (3) | 1.5 | CG1:CG2 | ET2A | — | HT2A | 1.59 | 170 | 100 | G1 | G1 | G1 |
| 3 | | | 3:7 | 4 Parts | | 22 Parts | | | | | | |
| Example | (4) | 1.5 | CG1:CG2 | ET1A | HT1A | HT2A | 0.04 | 200 | 138 | G1 | G2 | G1 |
| 4 | | | 3:7 | 4 Parts | 12 Parts | 22 Parts | | | | | | |
| Example | (5) | 2.3 | CG1:CG2 | ET1A | HT1A | HT2A | 0.48 | 183 | 123 | G1 | G1 | G1 |
| 5 | | | 3:7 | 4 Parts | 12 Parts | 22 Parts | | | | | | |
| Example | (6) | 2.55 | CG1:CG2 | ET1A | HT1A | HT2A | 0.49 | 183 | 123 | G2 | G1 | G1 |
| 6 | | | 3:7 | 4 Parts | 12 Parts | 22 Parts | | | | | | |
| Example | (7) | 1.45 | CG1:CG2 | ET1A | HT1A | HT2A | 0.48 | 183 | 123 | G1 | G1 | G2 |
| 7 | | | 3:7 | 4 Parts | 12 Parts | 22 Parts | | | | | | |

TABLE 2

| | | Photosensitive layer | | | | | | | | | | |
|---|---|---|---|---|---|---|---|---|---|---|---|---|
| | | Charge generating | | Electron | | | | | | Evaluations | | |
| | | material | | transporting | Hole transporting | | Content of | | | | Ease of | |
| | Type of | | Type | material | material | | residual | Martens | Drying | | removal of | |
| | photo- | | Weight | Type | Type | Type | solvent | hardness | temperature | Charge- | foreign | Image |
| | receptor | Parts | ratio | Parts | Parts | Parts | [weight %] | [N/cm²] | [° C.] | ability | matter | density |
| Comparative | (C1) | 1.5 | CG1:CG2 | ET1A | HT1A | HT2A | 0.01 | 205 | 145 | G1 | G4 | G1 |
| example 1 | | | 3:7 | 4 Parts | 12 Parts | 22 Parts | | | | | | |
| Comparative | (C2) | 1.5 | CG1:CG2 | ET1A | HT1A | HT2A | 4.99 | 160 | 50 | G1 | G3 | G3 |
| example 2 | | | 3:7 | 4 Parts | 12 Parts | 22 Parts | | | | | | |
| Comparative | (C3) | 2.5 | CG1:CG2 | ET1A | HT1A | HT2A | 4.99 | 160 | 50 | G1 | G3 | G3 |
| example 3 | | | 3:7 | 4 Parts | 12 Parts | 22 Parts | | | | | | |
| Comparative | (C4) | 3.0 | CG1:CG2 | ET1A | HT1A | HT2A | 4.99 | 160 | 50 | G3 | G3 | G1 |
| example 4 | | | 3:7 | 4 Parts | 12 Parts | 22 Parts | | | | | | |
| Comparative | (C5) | 1.5 | CG1:CG2 | ET1A | HT1A | HT2A | 6.11 | 150 | 25 | G3 | G3 | G3 |
| example 5 | | | 3:7 | 4 Parts | 12 Parts | 22 Parts | | | | | | |
| Comparative | (C6) | 1.0 | CG1:CG2 | ET1A | HT1A | HT2A | 0.01 | 205 | 145 | G1 | G4 | G3 |
| example 6 | | | 3:7 | 4 Parts | 12 Parts | 22 Parts | | | | | | |
| Comparative | (C7) | 2.5 | CG1:CG2 | ET1A | HT1A | HT2A | 4.99 | 160 | 50 | G3 | G3 | G1 |
| example 7 | | | 2:8 | 4 Parts | 12 Parts | 22 Parts | | | | | | |
| Comparative | (C8) | 1.5 | CG3 | ET1A | HT1A | HT2A | 1.01 | 180 | 115 | G1 | G1 | G3 |
| example 8 | | | | 4 Parts | 12 Parts | 22 Parts | | | | | | |

The above results confirm that the photoreceptors prepared in Examples enabled foreign matter present in the surface of the photoreceptor to be more easily removed than the photoreceptors prepared in Comparative Examples. Furthermore, in Examples, high chargeability and a capability of forming images having a high density, which are the originally required functions of the photoreceptors, are maintained.

The photoreceptors prepared in Examples 1 to 5, which included a photosensitive layer including 1.5% by weight or more and 2.3% by weight or less of the specific phthalocyanine pigment that served as a charge generating material, had higher chargeability and are capable of forming images having higher densities than that prepared in Example 7, where the content of the specific phthalocyanine pigment is less than 1.5% by weight, or that prepared in Example 6, where the content of the specific phthalocyanine pigment is more than 2.3% by weight.

The results obtained in Comparative Example 8 confirm that, in the case where the photosensitive layer includes a titanyl phthalocyanine pigment, that is, a phthalocyanine pigment other than the specific phthalocyanine pigment, that serves as a charge generating material, the photoreceptor fails to maintain both high chargeability and the capability of forming images having a high density even when the Martens hardness Hm of the photosensitive layer is 170 N/mm² or more and 200 N/mm² or less.

The results obtained in Comparative Examples 2 to 5 and 7 confirm that, in the case where the Martens hardness Hm of the photosensitive layer is reduced to be less than 170 N/mm², the photoreceptor fails to maintain both high chargeability and the capability of forming images having a high density even when the photosensitive layer includes the certain content of the specific phthalocyanine pigment that serves as a charge generating material.

The above results confirm that the photoreceptors prepared in Examples above, which included a photosensitive layer that had a Martens hardness Hm of 170 N/mm² or more and 200 N/mm² or less and included the specific phthalocyanine pigment that served as a charge generating material, enabled foreign matter present in the surface of the photoreceptor to be easily removed and maintained both high chargeability and the capability of forming images having a high density.

The abbreviations used in Tables 1 and 2 above are described in detail below.

Charge Generating Material
CG1: The charge generating material represented by the structural formula below (i.e., hydroxygallium phthalocyanine pigment)

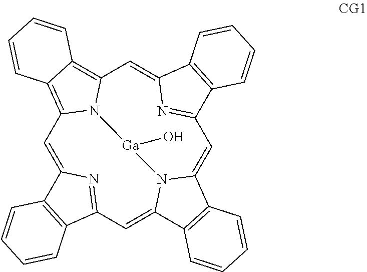

CG2: The charge generating material represented by the structural formula below (i.e., chlorogallium phthalocyanine pigment)

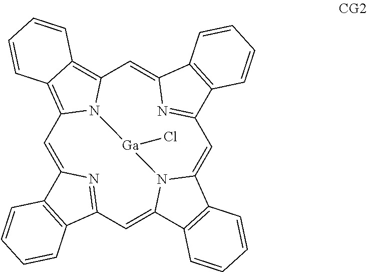

CG3: Titanyl phthalocyanine pigment

Electron Transporting Material
ET1A: The electron transporting material represented by the structural formula below (i.e., the exemplified compound ET1-2)

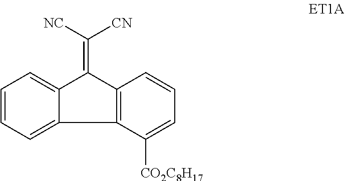

ET2A: The electron transporting material represented by the structural formula below (i.e., 3,3′-di-tert-butyl-5,5′-dimethyldiphenoquinone, exemplified compound ET2-3)

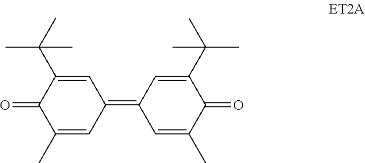 [SMILES: CC1=C/C(=C2\C=C(C)C(=O)C(C(C)(C)C)=C2)C=C(C(C)(C)C)C1=O]

Hole Transporting Material
HT1A: The hole transporting material represented by structural formula below (i.e., the exemplified compound HT1-4)

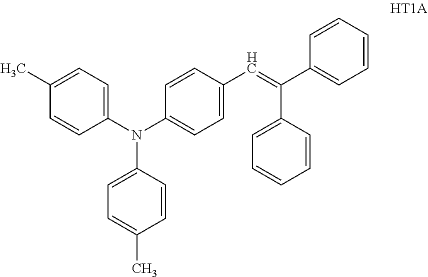 [SMILES: Cc1ccc(N(c2ccc(C)cc2)c2ccc(C=C(c3ccccc3)c3ccccc3)cc2)cc1]

HT2A: The hole transporting material represented by the structural formula below (i.e., the exemplified compound HT2-3)

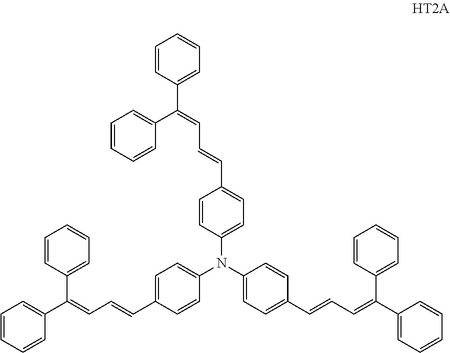 [SMILES: C(/C=C/c1ccc(N(c2ccc(/C=C/C=C(c3ccccc3)c3ccccc3)cc2)c2ccc(/C=C/C=C(c3ccccc3)c3ccccc3)cc2)cc1)=C(c1ccccc1)c1ccccc1]

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate; and
a single-layer photosensitive layer on the conductive substrate,
the photosensitive layer including:
a binder resin,
at least one charge generating material selected from a hydroxygallium phthalocyanine pigment and a chlorogallium phthalocyanine pigment,
a hole transporting material, and
an electron transporting material,
the photosensitive layer having a Martens hardness Hm of 170 N/mm² or more and 200 N/mm² or less.

2. The electrophotographic photoreceptor according to claim 1,
wherein the Martens hardness Hm of the photosensitive layer is 175 N/mm² or more and 195 N/mm² or less.

3. The electrophotographic photoreceptor according to claim 1,
wherein the Martens hardness Hm of the photosensitive layer is 180 N/mm² or more and 190 N/mm² or less.

4. The electrophotographic photoreceptor according to claim 1,
wherein the content of a residual solvent in the photosensitive layer is 0.04% by weight or more and 1.6% by weight or less of the total weight of the photosensitive layer.

5. The electrophotographic photoreceptor according to claim 1,
wherein the content of a residual solvent in the photosensitive layer is 0.5% by weight or more and 1.3% by weight or less of the total weight of the photosensitive layer.

6. The electrophotographic photoreceptor according to claim 1,
wherein the content of a residual solvent in the photosensitive layer is 0.8% by weight or more and 1.1% by weight or less of the total weight of the photosensitive layer.

7. The electrophotographic photoreceptor according to claim 1,
wherein the content of the charge generating material is 1.4% by weight or more and 2.6% by weight or less of the total weight of the photosensitive layer,
wherein the electron transporting material is at least one selected from an electron transporting material represented by General Formula (ET1) below and an electron transporting material represented by General Formula (ET2) below, and
wherein the hole transporting material is at least one selected from a hole transporting material represented by General Formula (HT1) below and a hole transporting material represented by General Formula (HT2) below, 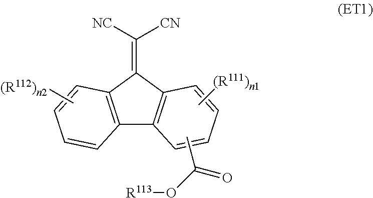
where R¹¹¹ and R¹¹² each independently represent a halogen atom, an alkyl group, an alkoxy group, an aryl group, or an aralkyl group; R¹¹³ represents an alkyl group, a -L¹¹⁴-O—R¹¹⁵ group, an aryl group, or an aralkyl group, the L¹¹⁴ being an alkylene group and the R¹¹⁵ being an alkyl group; and n1 and n2 each independently represent an integer of 0 to 3, 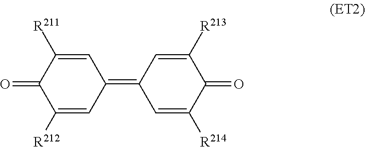
where R²¹¹, R²¹², R²¹³, and R²¹⁴ each independently represent a hydrogen atom, an alkyl group, an alkoxy group, a halogen atom, or a phenyl group, 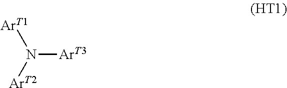
where Ar^{T1}, Ar^{T2}, and Ar^{T1} each independently represent an aryl group or a —C₆H₄—C(R^{T4})═C(R^{T5})(R^{T6}) group, where R^{T4}, R^{T5}, and R^{T6} each independently represent a hydrogen atom, an alkyl group, or an aryl group and R^{T5} and R^{T6} may be bonded to each other to form a hydrocarbon ring structure, 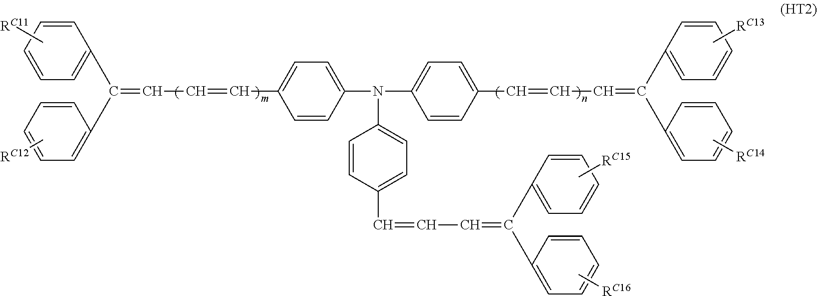
where R^{C11}, R^{C12}, R^{C13}, R^{C14}, R^{C15}, and R^{C16} each independently represent a hydrogen atom, a halogen atom, an alkyl group having 1 to 20 carbon atoms, an alkoxy group having 1 to 20 carbon atoms, or an aryl group having 6 to 30 carbon atoms; a pair of adjacent substituent groups may be bonded to each other to form a hydrocarbon ring structure; and n and m each independently represent 0, 1, or 2.

8. The electrophotographic photoreceptor according to claim 7,
wherein the content of the charge generating material is 1.5% by weight or more and 2.3% by weight or less of the total weight of the photosensitive layer.

9. A process cartridge detachably attachable to an image forming apparatus,
the process cartridge comprising the electrophotographic photoreceptor according to claim 1.

10. An image forming apparatus comprising:
the electrophotographic photoreceptor according to claim 1;
a charging unit that charges a surface of the electrophotographic photoreceptor;
an electrostatic-latent-image forming unit that forms an electrostatic latent image on the charged surface of the electrophotographic photoreceptor;
a developing unit that develops the electrostatic latent image formed on the surface of the electrophotographic photoreceptor with a developer containing a toner in order to form a toner image; and
a transfer unit that transfers the toner image onto a surface of a recording medium.
